(19) United States
(12) Patent Application Publication
(10) Pub. No.: US 2005/0262264 A1
(43) Pub. Date: Nov. 24, 2005

(54) MPLS network and architecture method thereof

(76) Inventors: Tatsuhiro Ando, Kawasaki (JP); Kinya Yamazaki, Kawasaki (JP); Takeshi Fujiwara, Kawasaki (JP)

Correspondence Address: KATTEN MUCHIN ROSENMAN LLP, 575 MADISON AVENUE, NEW YORK, NY, 10022-2585, US

(21) Appl. No.: 10/945,516

(22) Filed: Sep. 20, 2004

(30) Foreign Application Priority Data
May 24, 2004 (JP) 2004-153588

(51) Int. Cl. G06F 15/16

(52) U.S. Cl. 709/233

(57) ABSTRACT

An MPLS network is hierarchized into upper and lower layer MPLS networks, in which the upper layer MPLS network has TE-LSP for a resource guarantee set up in a mesh form, and at least one lower layer MPLS network has TE-LSP for a resource guarantee set up in a mesh form independently of the upper layer MPLS network. TE-LSP's for a forwarding resource guarantee are set up between routers within the lower layer MPLS network and a gateway router designated within the upper layer MPLS network, and connected to the TE-LSP set up within the upper layer MPLS network.

### BACKGROUND OF THE INVENTION

1. Field of the Invention

The present invention relays to an MPLS network and architecture method thereof and in particular to an MPLS network and architecture method thereof for accommodating to a large-scale network configuration and a resource (bandwidth) guaranteeing service from end to end.

2. Description of the Related Art

In order for a previously known general MPLS network to provide a desired QoS (Quality of Service), a router relaying within the network guarantees a resource in accordance with the service. For a resource guarantee in each relaying router, or a resource reservation from end to end (between terminals), a TE-LSP (Traffic Engineering-Label Switched Path) is set up between edge routers (hereinafter, occasionally referred to as a gateway router) by a signaling protocol such as a RSVP (resource reservation protocol). It is to be noted that the TE-LSP will be used as a terminology for unifying an LSP, tunnel, RSVP path, MPLS-TE tunnel, or a resource guarantee path.

Meanwhile, in a packet communication network such as an IP network, there is proposed a managing method of an internet protocol connection-oriented service which is carried out in an user tunnel set up in an engineering tunnel structured over networks, and provides an end to end connection without routing individual packets in middle network nodes (see e.g. patent document 1).

There is also provided an inter-network relaying method and inter-network relaying device comprising a first retrieval process for retrieving a layer 4 label for determining to which application server a packet is addressed based on at least a destination port number included in the layer 4 header of the packet, a second retrieval process for retrieving a terminal point designating label which designate the terminal point of a MPLS path based on a destination address included in a layer 3 header of the packet, and a forwarding process for forwarding the corresponding packet by capsulating same in the order of the above terminal point designating label, the above layer 4 label, and layer 3 packet (see e.g. patent document 2).
[patent document 1] Japanese translation of PCT international application No. 2002-530939
[patent document 2] Japanese patent application laid-open No. 2001-7848
   Problem 1

In order to guarantee the resource for various services, as shown in FIG. 40, it was previously required to reserve or secure the resource by setting up the TE-LSP in a full mesh form between gateway routers R_{U}1-R_{U}n within a backbone network NW_{BB} subordinating access networks NW_{A}(NW_{Aa}-NW_{Ah}). However, this requirement raised no particular problems for an operator's management such as setting, resetting, or measuring the TE-LSP because the number of TE-LSP is small if the backbone network NW_{BB} is a small-scale network.

However, as the scale of the backbone network NW_{BB} becomes large, the number of the gateway routers increases, so that setting up the TE-LSP between the gateway routers explosively increases the number of the TE-LSP, practically disabling the operator's management.

Since resource guaranteeing services are made between the routers, if the gateway router number n=100 for example, for setting up the resource-guaranteed TE-LSP, the number of TE-LSP will be, in total of up and down directions:
TE-LSP number required=gateway router number n×(gateway router number−1)=9900 (1)

This is approximately 10,000 and is disadvantageously over the limit of operator's management.

On the other hand, even in the case of hierarchization by using a prior art label stack technology, there was no method except setting up the resource-guaranteed TE-LSP between the gateway routers for the resource guarantee.

Problem 2

If an MPLS network having solved the above problem 1 is realized, a new problem will arise as to how such an MPLS network should be connected to an existing network.

Problem 3

Even though the resource is reserved from to end to end, the traffic does not always flow, so that a network operator occasionally prepares only a resource in conformity with the utilization status without preparing the maximum resource. In this occasion, it is possible that a traffic inflow more than the TE-LSP resource set up from end to end causes some packet loss.

### SUMMARY OF THE INVENTION

It is accordingly an object of the present invention to provide an MPLS network and an architecture method thereof in which the number of TE-LSP is reduced, operator's managements are largely facilitated, a mutual connection with an existing MPLS network can be made, and a packet loss is hard to occur.

Solution for Problem 1

In order to achieve the above-mentioned object, an MPLS network according to the present invention comprises; an upper layer MPLS network having a TE-LSP for a resource guarantee set up in a mesh form, and at least one lower layer MPLS network having a TE-LSP for a resource guarantee set up in a mesh form independently of the upper layer MPLS network, a TE-LSP for a forwarding resource guarantee being set up between routers within the lower layer MPLS network and a gateway router designated within the upper layer MPLS network, and being connected to the TE-LSP set up within the upper layer MPLS network being mutually connected.

Namely, the conventional backbone network NW_{BB} shown in FIG. 40 is hierarchized or layered into at least an upper layer network NW_{U} and a lower layer network NWn as shown FIG. 1. The upper layer network NW_{U} is composed of routers R_{U}1 . . . R_{U}5, in which TE-LSP's for the respective resource guarantees are previously set up in a mesh form. The lower layer network NWL is composed of networks NW_{L}1 . . . NW_{L}2, in which TE-LSP's for the respective resource guarantees are set up in a mesh form independently of the upper layer MPLS network NW_{U}. For example in the lower layer network NW_{L}1, TE-LSP's are mutually set up in a mesh form among routers R_{L}11 . . . R_{L}12. Similarly in the lower layer network NW_{L}2, TE-LSP's are also mutually set up in a mesh form among routers R_{L}21 . . . R_{L}22.

Also in the lower layer MPLS network NW_{L}1, between the routers R_{L}11 . . . R_{L}12 and a gateway router R_{U}1 preliminarily designated within the upper layer network NW_{U}, a TE-LSP1 which is a tunnel (path) for a forwarding resource guarantee is set up. Similarly in the lower layer MPLS network NW_{L}2, between the routers R_{L}21 . . . R_{L}22 and a gateway router R_{U}2 within the upper layer MPLS network NW_{U}, a TE-LSP3 is also set up.

Thus, resource guaranteeing TE-LSP's are set up independently of the respective layer network areas, and the TE-LSP's between the layers are mutually connected, whereby the number of TE-LSP's can be reduced. Therefore, a resource can be effectively secured from end to end, and operator's manual management works can be largely reduced.

Accordingly, an architecture method of the MPLS network according to the above-noted invention comprises; a first step of hierarchizing an MPLS network into a plurality of MPLS networks, a second step of setting up a TE-LSP for a resource guarantee in a mesh form independently in each of the MPLS networks, and a third step of setting up a TE-LSP for a forwarding resource guarantee between routers within a lower layer MPLS network and a gateway router within an upper layer MPLS network determined at the first step, and of mutually connecting the TE-LSP for a forwarding resource guarantee to the TE-LSP set up within the upper layer MPLS network.

Namely, at a first step, an MPLS network is hierarchized or layered into a plurality of MPLS networks as above-noted. At a second step, in networks NW_{U} and NW_{L} (see FIG. 1) respectively of an upper layer and lower layer, TE-LSP's are set up in a mesh form by using RSVP-TE signaling protocol or the like for guaranteeing a forwarding resource among routers in the networks. Then at a third step, between the routers within the lower layer MPLS network NW_{L} and the gateway routers R_{U}1, R_{U}2 preliminarily designated within the upper layer MPLS network NW_{U}, the TE-LSP1 and TE-LSP3 for a guaranteeing a forwarding resource are set up. Furthermore, the TE-LSP1 and TE LSP3 thus set up are connected to the TE-LSP2 set up between the gateway routers R_{U}1-R_{U}2 within the upper layer network NW_{U}, thereby establishing a resource guarantee from end to end over the entire network.

In the above-noted MPLS network, when having found an IP packet received to be forwarded through the upper layer network from its destination IP address from its destination IP address, the routers within the lower layer MPLS network may be set up to embed the IP packet with a destination network ID and a gateway router ID as MPLS label information to be forwarded.

Thus, it becomes possible to effectively and rapidly determine which TE-LSP should be connected, and to reduce the usage in a memory area necessary for the processing.

It is to be noted that when a router is added and switched on in the lower layer network, after the initial setting or the like of the router, TE-LSP's to the gateway routers of the upper layer are set up by means of RSVP-TE protocol or the like.

Also, in the above-noted MPLS network, a TE-LSP for a resource guarantee may be set up between the MPLS networks of same layer, and when having found an IP packet received to be forwarded through the same layer networks, the routers within the lower layer MPLS network may be set up to pass the IP packet through the TE-LSP set up between the same layer MPLS networks without MPLS labeling operations.

Therefore, in case the lower layer network is not necessarily connected to the upper layer network, the TE-LSP's are mutually connected within the same layer network area, not to a different layer, so that the MPLS label information can be penetrated as it is without being superimposed.

Also, the lower layer networks can be directly connected with each other without being connected to the upper layer network so that packets can be directly forwarded among the same layers, resulting in a flexible network configuration.

Moreover, in case the packet in the lower layer network does not necessarily have to pass through the upper layer network, for example the upper layer network is geographically distant from the lower layer network or a traffic to such an extent as to pass through the upper layer network of a high speed and a large capacity does not arise, an additional support for the network can be facilitated.

Furthermore, the routers within the lower layer MPLS network may be initially set up to switch the label information with all other routers within each of the networks by a signaling protocol.

Namely, by automatically broadcasting the label information of its own with a signaling protocol such as a multi-protocol BGP, the label information (network ID+router ID) other than its own is acquired not by an operator's manual setting or reading a setup file, whereby the label information of the routers within the network can be autonomically switched (distributed and acquired). The label information can be automatically acquired, so that operator's management works can be largely reduced since the operator is not required to input label information one by one.

Also, in the above-noted MPLS network, a route reflector may be arranged in the gateway router, and the routers within the lower layer MPLS network are initially set up to switch the label information through the route reflector.

Namely, within the upper layer network, the label information is switched among the route reflectors, so that the label information received from other route reflectors can be further broadcast within the lower layer network.

Thus, the label information is switched through the route reflectors arranged in the gateway routers for a further efficient switching process of the label information, enabling operator's preliminary setup works to be reduced. Since the label information can be switched only by designating the route reflectors as a destination without BGP peer settings to all of the routers in other network areas as regards the routers within each of the lower layer networks, operator's manual settings can be reduced.

The above-noted MPLS network may further comprise at least one MPLS label server which is set up to perform a unitary management and distribution of the label information for all routers within each of the network.

Thus, in stead of automatically switching the above-noted label information, a label server is arranged for a batch/concentrated management of the label information to be received from the routers or folded back from other routers, whereby it becomes possible to omit the distribution process of the label information from the routers and to decrease the burden on a CPU processing of the routers.

Also, in the above-noted MPLS network, the MPLS label server may be arranged in each of the MPLS networks and may be set up to perform a unitary management and distribution of the label information for all routers within its subordinate network and to switch the label information between the label servers.

Thus, the label server may be provided for each MPLS network, whereby a label switching such as BGP processing can be omitted by interconnecting the label servers respectively arranged in the network areas according to the network scale to efficiently distribute the label information. In this case, the label switching between the label servers may adopt to transmit/receive the label information every time a single label information is acquired, or to transmit/receive the label information as acquired and then accumulated in the mass at a constant time interval.

Solution for problem 2

When the above-described MPLS network that is scalable is connected to an existing MPLS network, and when the gateway router within the scalable MPLS network provided on the border with the existing MPLS network switches the label information with the routers in the existing MPLS network and receives a resource request for the routers within the existing MPLS network from the network of its own, the gateway router may set up the TE-LSP for the routers based on the switched label information.

Namely, by a gateway router (edge router) arranged on the border between an existing MPLS network and a scalable MPLS network for achieving a QoS-guaranteed mutual connection based on the present invention as mentioned-above, the scalable MPLS network is connected to the existing MPLS network by the conventional QoS-guaranteed connection where the label information of this case is an existing one used in the existing MPLS network which is different from the label information used in the above present invention. Between the networks using the present invention, the present invention is adapted. Therefore, a QoS-guaranteed mutual connection between the existing MPLS network and the scalable MPLD network according to the present invention is realized.

The above-noted scalable MPLS network may be connected to be sandwiched between the existing MPLS networks, and may be adapted, upon receipt of a resource request from routers in one of the existing MPLS networks to those in the other, to make the gateway router within the scalable MPLS network set up a corresponding TE-LSP based on the label information.

Namely, also in an inter-network connection of the existing MPLS network—the scalable MPLS network according to the present invention—the existing MPLS network, such a resource guarantee can be similarly made from end to end of the network.

Moreover, the above-noted scalable MPLS network may be pluralized so as to be mutually connected to sandwich an existing MPLS network, and may be adapted, upon receipt of a resource request from routers in one of the scalable MPLS networks to the other, to set up a corresponding TE-LSP between the gateway routers of the scalable MPLS networks.

Also in this case, a mutual connection of the scalable MPLS network according to the present invention the existing MPLS network the scalable MPLS network according to the present invention is realized, enabling a resource guarantee from end to end of the network.

It is to be noted that an MPLS label server may be arranged in each scalable MPLS network, and is set up to perform a unitary management and distribution of the label information for all routers within its subordinate network and to switch the label information between the label servers.

Namely, in such a mutual connection of the scalable MPLS network according to the present invention and the existing MPLS network as noted-above, it becomes possible to switch the label information with respect to all of the routers in all of the networks from an MPLS label server provided for each scalable MPSL network.

Solution for problem 3

In the above-noted hierarchized MPLS network (see FIG. 1), a plurality of resource-guaranteed TE-LSP's may be set up between an ingress gateway router and an egress gateway router within a same MPLS network, and the MPLS network may further comprise an external server which is set up, upon receipt of a resource request from a source terminal, to select a TE-LSP whose resource is reservable and to broadcast identifying information of the TE-LSP to the routers within the MPLS networks.

Namely, in the above-mentioned MPLS network, at least two or more resource-guaranteed TE-LSP's are prepared for the same destination, and an external server broadcasts to the routers within the network that a TE-LSP which has been recognized to be able to reserve the resource is an applicable route, thereby avoiding a packet loss generated when a traffic higher than the resource is unexpectedly flown into the TE-LSP. In this case, after confirming the presence or absence of the resource within the TE-LSP, the external server uniquely determines an applicable TE-LSP, and broadcasts the applicable TE-LSP to the routers within the network, thereby preventing a packet loss due to a lack of resource from being generated.

Alternatively a plurality of resource-guaranteed TE-LSP may be set up between an ingress gateway router and an egress gateway router within a same MPLS network, and the MPLS network may further comprise an external server which is set up, upon receipt of a resource request from a source terminal, to select a TE-LSP whose resource is reservable, and to notify identifying information of the TE-LSP to the ingress gateway router, the ingress gateway router being responsively set up to broadcast the identifying information to other routers.

Namely, the external server uniquely determines an applicable route after confirming the presence or absence (margin) of the resource in the TE-LSP and notifies it to an ingress gateway router, which broadcasts the applicable route to the routers within the network, thereby preventing a packet loss due to a lack of resource from being generated.

Alternatively, a plurality of resource-guaranteed TE-LSP's may be set up between an ingress gateway router and an egress gateway router within a same MPLS network, and the ingress gateway router is set up, upon receipt of a resource request from a source terminal, to select a TE-LSP whose resource is reservable and to broadcast identifying information of the TE-LSP to other routers.

Namely, the ingress router uniquely determines an applicable route after confirming the presence or absence (margin) of the resource in the TE-LSP and broadcasts the applicable route to the routers within the network, thereby preventing a packet loss due to a lack of resource from being generated.

Also, the MPLS network may be pluralized so as to be connected in cascade, each of which is provided with an external server, and resource information of the MPLS network managed by itself may be sequentially forwarded between adjoining external servers.

Furthermore, the MPLS network may be pluralized so as to be connected in cascade, and resource information of the MPLS network managed by itself is sequentially forwarded between the egress gateway router and the ingress gateway router of adjoining MPLS networks.

Namely, in case a TE-LSP provided from end to end is set up through a plurality of MPLS networks, and the resources of the MPLS networks are managed by an ingress router within the MPLS networks, the ingress router uniquely determines an applicable route after confirming the presence or absence (margin) of the resource and broadcasts the applicable route to the routers within the network, thereby preventing a packet loss due to a lack of resource from being generated.

Also, when the set up TE-LSP bridges the pluralized MPLS networks, a destination route ID indicating which TE-LSP should be connected may be embedded in the label information.

This case realizes a unique determination of a TE-LSP to be connected based on a route ID, so that the packet forwarding can be simplified and enhanced in speed and the usage of memory area can be saved.

As above-mentioned, by hierarchizing a large-scale network into at least two layers, and dividing a resource guaranteeing path (TE-LSP) into the layers, the number of TE-LSP can be largely reduced compared with the prior art, there by advantageously facilitating operator's managements remarkably.

Also, a QoS-guaranteed mutual connection between the scalable MPLS network according to the present invention and the existing MPLS network not using the scalable MPLS network can be realized.

Furthermore, although there is a case that even if the resource is reserved from end to end, a traffic does not always flown so that a network operator prepares only a resource in conformity with the utilization status without preparing the maximum resource, and that a packet loss occurs when a traffic higher than the resource of TE-LSP set up from end to end is flown into the network, the application of the present invention enables such a packet loss due to communications in a resource lacking state to be avoided, thereby realizing communications in networks having reserved the resources.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a diagram showing an entire configuration for describing an MPLS network and architecture method thereof according to the present invention;

FIG. 2 is a flow chart showing a process of an architecture method of an MPLS network according to the present invention;

FIG. 3 is a block diagram showing a router arrangement [1] used for the present invention;

FIG. 4 is a diagram showing a format (1) of an MPLS label used for the present invention;

FIG. 5 is a sequence diagram showing a resource reservation process according to an embodiment [1] of the present invention;

FIG. 6 is a diagram showing a preparation process and contents of a forwarding information table in an embodiment [1] of the present invention;

FIG. 7 is a flow chart showing a packet transmitting/receiving process example in a router according to the present invention;

FIG. 8 is a diagram showing an operation example in an embodiment [1] of the present invention;

FIG. 9 is a diagram showing an operation example in an embodiment [2] of the present invention;

FIG. 10 is a sequence diagram showing a resource reservation process according to an embodiment [2] of the present invention;

FIG. 11 is a diagram showing a forwarding information table in an embodiment [2] of the present invention;

FIG. 12 is a flow chart showing a BGP label switching process used in the present invention;

FIG. 13 is a diagram showing a label information switching example (1) according to the present invention;

FIG. 14 is a sequence diagram showing a resource reservation process in a label information switching example (1) according to the present invention;

FIG. 15 is a diagram showing a label information switching example (2) according to the present invention;

FIG. 16 is a sequence diagram showing a resource reservation process in a label information switching example (2) according to the present invention;

FIG. 17 is a diagram showing a label information switching example (3) according to the present invention;

FIG. 18 is a sequence diagram showing a resource reservation process in a label information switching example (3) upon adding routers according to the present invention;

FIGS. 19A-19C are diagrams showing mutually connected-pattern examples between a scalable MPLS network and an existing MPLS network;

FIG. 20 is a block diagram showing a router arrangement [2], used for the present invention, which mutually connects a scalable MPLS network and an existing MPLS network;

FIG. 21 is a sequence diagram showing a resource reservation process between existing MPLS network-scalable MPLS network;

FIG. 22 is a sequence diagram showing a resource reservation process between existing MPLS network-scalable MPLS network-existing MPLS network;

FIG. 23 is a sequence diagram showing a resource reservation process between scalable MPLS network-existing MPLS network-scalable MPLS network;

FIG. 24 is a sequence diagram showing a resource reservation process when an external server is employed for hetero-MPLS network connection;

FIG. 25 is a block diagram showing an entire configuration when a plurality of TE-LSP's are set up for the same destination;

FIG. 26 is a block diagram showing a resource management example (1) by an external server in the present invention;

FIG. 27 is a sequence diagram of a resource management example (1) in FIG. 26;

FIG. 28 is a block diagram showing an external server resource management example (2) in the present invention;

FIG. 29 is a sequence diagram of a resource management example (2) in FIG. 28;

FIG. 30 is a block diagram showing an external server resource management example (3) in the present invention;

FIG. 31 is a sequence diagram of a resource management example (3) in FIG. 30;

FIG. 32 is a block diagram showing an external server resource management example (4) in the present invention;

FIG. 33 is a sequence diagram of a resource management example (4) in FIG. 32;

FIG. 34 is a block diagram showing an external server resource management example (5) in the present invention;

FIG. 35 is a sequence diagram of a resource management example (5) in FIG. 34;

FIG. 36 is a block diagram showing an external server resource management example (6) in the present invention;

FIG. 37 is a sequence diagram of a resource management example (6) in FIG. 36;

FIG. 38 is a diagram showing an arrangement [3] of a forwarding information table (FIB) used for the present invention;

FIG. 39 is a diagram showing a format (2) of a MPLS label used for the present invention; and

FIG. 40 is a diagram showing a prior art network configuration.

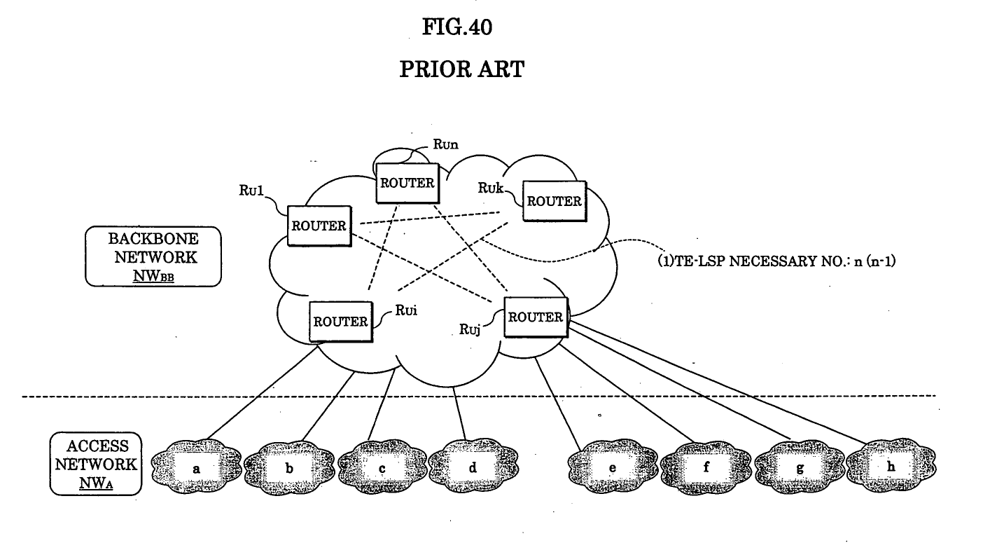

### DESCRIPTION OF THE EMBODIMENTS

### Embodiment [1] (for Problem 1)

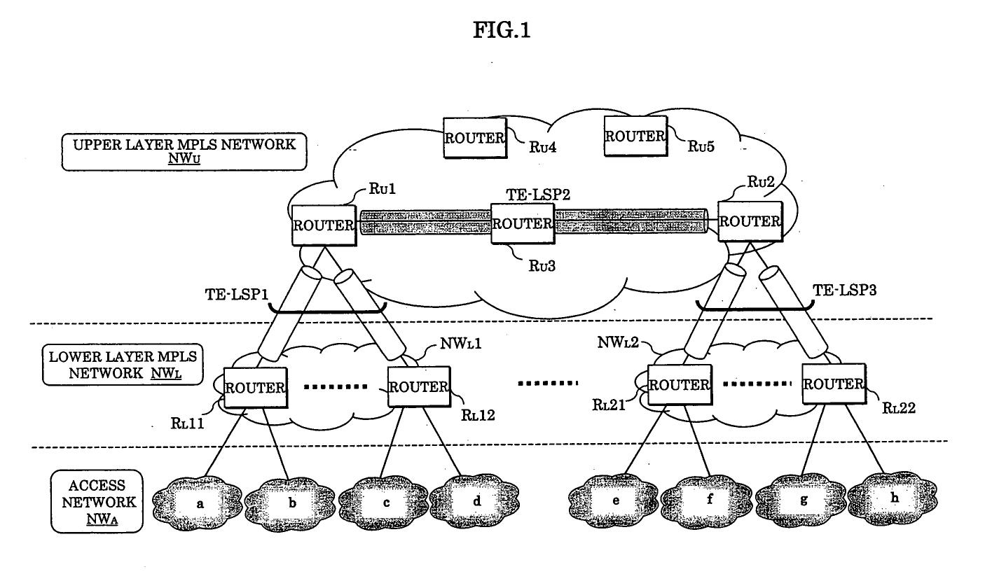

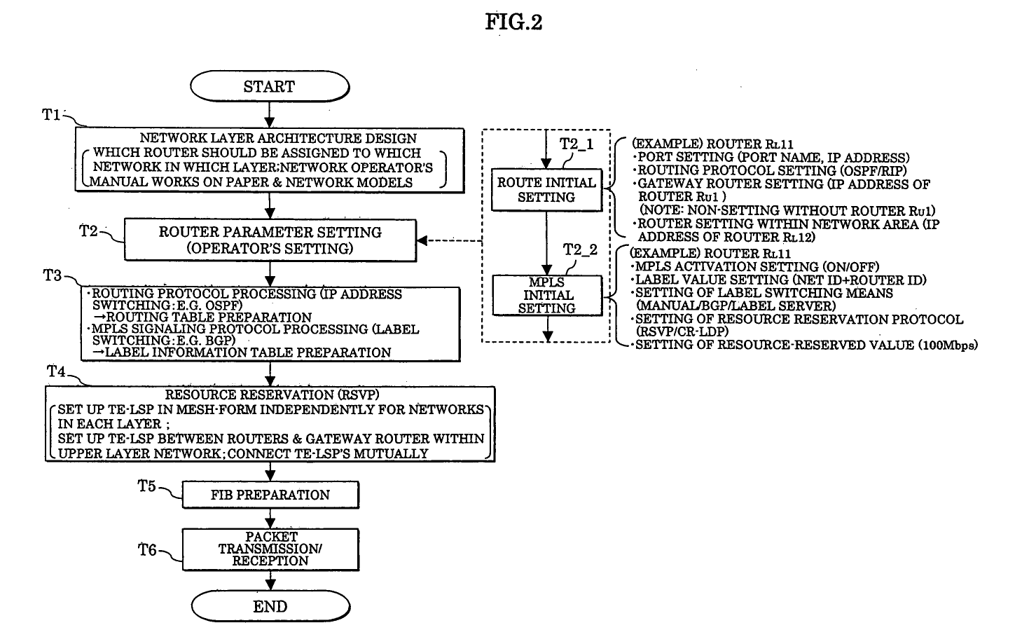

FIG. 2 shows a process (steps T1-T6) of an architecture method of an MPLS network according to the present invention shown in FIG. 1, which will now be described per each step.

Step T1:

At first, a network managing operator designs a network layer architecture. Specifically, in case where a network used for the present invention is hierarchized or layered into at least an upper layer network NW_{U} and a lower layer network NW_{L} as shown in FIG. 1, the operator determines which router among all of the routers should be assigned to the upper layer network NW_{U} and how many network areas the lower layer network NW_{L} should be divided. Also, the operator determines, according to the above division, which router should be assigned to the lower layer network NW_{L}1 and which router should be assigned to the lower layer network NW_{L}2 in the example of FIG. 1. As a result, the operator manually prepares a network model on paper.

On this occasion, with respect to the lower layer MPLS network NW_{L}1, the operator preliminarily designates a router R_{U}1 in the upper layer MPLS network NW_{U} as a gateway router, and with respect to the lower layer MPLS network NW_{L}2, designates a router R_{U}2 in the upper layer MPLS network NW_{U} as a gateway router. Also, with respect to access networks NW_{Aa}, NW_{Bb}, the operator assigns a router R_{L}11 in the lower layer MPLS network NW_{L}1 as a gateway router, and with respect to access networks NW_{Ac}, NW_{Ad}, assigns a router R_{L}12 as a gateway router. Similarly, with respect to access networks NW_{Ae}, NW_{Af}, the operator assigns a router R_{L}21 in the lower layer network NW_{L}2 as a gateway router, and with respect to access networks NW_{Ag}, NW_{Ah}, assigns a router R_{L}22 as a gateway router.

Step T2:

Then, parameter settings are performed for the routers as assigned above, which are operator's setting works. These parameter setting works comprise a route initial setting (step T2_1) and an MPLS initial setting (step T2_2) as indicated on the right side of step T2 by dotted lines in FIG. 2.

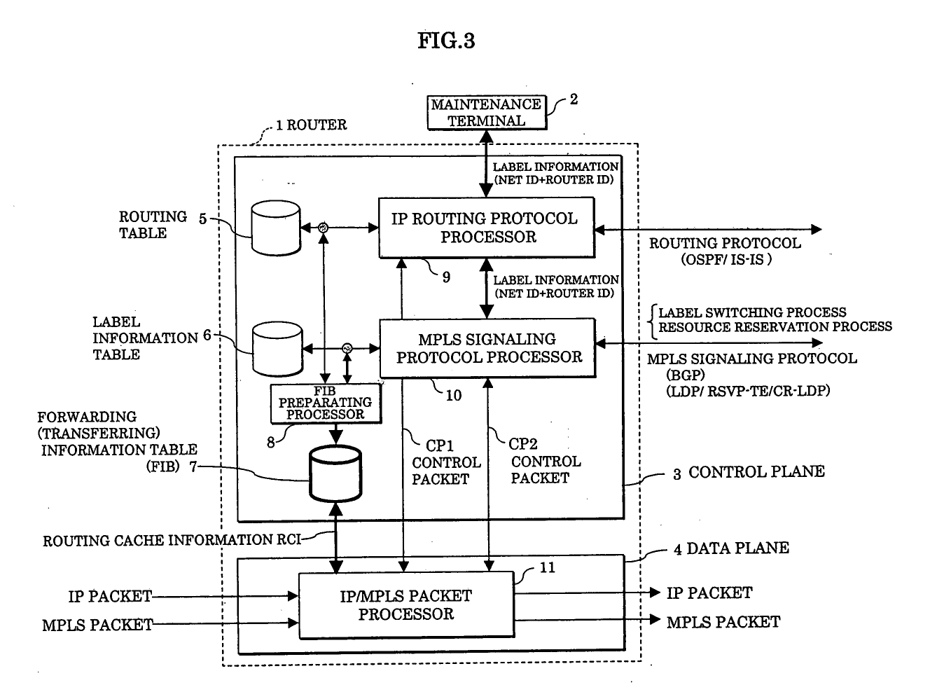

An arrangement [1] of each router will be described referring to FIG. 3. This router 1 is composed of a control plane 3 connected to a maintenance terminal 2, and a data plane 4 mutually connected to the control plane 3. The control plane 3 is further composed of a routing table 5, a label information table 6, and a forwarding (transferring) information table (FIB) 7, in which the forwarding information table 7 is connected to the routing table 5 and the label information table 6 through an FIB preparating processor 8.

The control plane 3 is further composed of an IP routing protocol processor 9 and an MPLS signaling protocol processor 10. The IP routing protocol processor 9 is connected to the maintenance terminal 2 as well as a similar IP routing protocol processor 9 in other routers to perform an IP routing protocol processing such as OSPF or IS-IS, thereby switching an IP address with an opponent router (peer router) to be stored in the routing table 5. The MPLS signaling protocol processor 10 uses a BGP protocol and an MPLS signaling protocol such as RSVP-TE or CR-LDP to perform label switching and resource reservation processing respectively with a similar MPLS signaling protocol processor in the opponent router, thereby storing the resultant label information in the label information table 6. It is to be noted that the IP routing protocol processor 9 and the MPLS signaling protocol processor 10 are connected to the maintenance terminal 2 to forward or transfer the label information (network ID and router ID (node ID)).

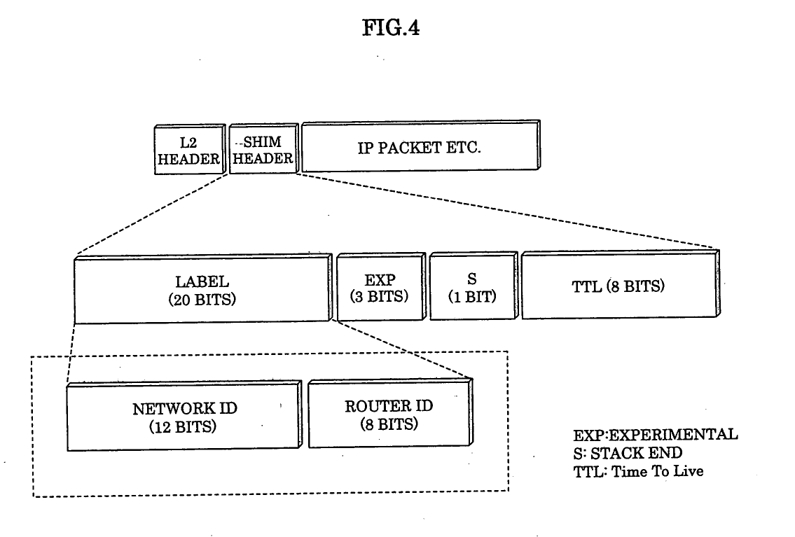

This label information is, as shown in FIG. 4, redefined with a label value (20 bits), within an MPLS header (shim header), consisting of a network ID (for example 12 bits) and router ID (for example 8 bits), both or either one of which is used to uniquely determine a TE-LSP to be connected when TE-LSP's are mutually connected between layers.

The data plane 4 includes an IP/MPLS packet processor 11 which transmits/receives an IP packet or an MPLS packet to/from an opponent router. For this purpose, the data plane 4 exchanges control packets CP1, CP2 with the processors 9 and 10 in the control plane 3 and exchanges a routing cache information RCI with the forwarding information table 7. It is to be noted that the forwarding information table 7 is a correspondence table between the label information, output port, and output TE-LSP as will be described. Back to FIG. 2, in the route initial setting (step T2_1), taking the router R_{L}11 in the lower layer MPLS network NW_{L}1 shown in FIG. 1 as an example, the IP routing protocol processor 9 performs port settings (port name, IP address) and settings of OSPF or IS-IS as a routing protocol as above-mentioned, and then settings of the gateway router as seen from the router R_{L}11.

In this connection, since the gateway router opposing the router R_{L}11 is the router R_{U}1 in the upper layer MPLS network NW_{U}, the IP address of the router R_{U}1 is set up. However, in the absence of the router R_{U}1, that is, in the absence of the upper layer MPLS network because of the corresponding router positioned in the upper layer, such settings are not performed. Namely, to which layer the router belongs depends on whether or not the gateway router is set up. Also, as a router within the network area, the IP address of the router R_{L}12 is set up as shown in the example of FIG. 1 and is stored in the routing table 5.

Also, taking the router R_{L}11 as an example at the MPLS initial setting (step T2_2), MPLS activation settings are made “ON”, and its own label information (network ID+router ID) is set up. Furthermore, for label information switching means, manual settings or settings with BGP or label servers is mentioned, any one of which can be adopted in this embodiment. Also for the resource reservation protocol, RSVP or CR-LDP is mentioned to set up for example “100 Mbps” for the resource reservation value.

Step T3:

Next, the routing protocol processing and the MPLS signaling protocol processing are respectively executed.

At the routing protocol processing, the IP routing protocol processor 9 performs IP address switching with an opponent router such as distributing the IP address with the routing protocol OSPF and acquiring the IP address from the opponent router, and stores the resultant IP address in the routing table 5.

At the MPLS signaling protocol processing, the MPLS signaling protocol processor 10 switches the label information (network ID+router ID) with an MPLS signaling protocol processor in the opponent router by using e.g. BGP, and stores the resultant label information in the label information table 6.

Step T4:

Next, a resource reservation is executed. This is done by the MPLS signaling processor 10 which uses the MPLS signaling protocol RSVP-TE or CR-LDP with the MPLS signaling processor in the opponent router to set up TE-LSP's in a mesh form independently of other networks in its own network NW_{L}1. Accordingly, this setup processing in a mesh form is to be performed independently of the upper layer MPLS network NW_{U} or the lower layer MPLS network NW_{L}2. Also, the router R_{L}11 sets up a TE-LSP1 with the router R_{U}1 preliminarily designated as a gateway router in the upper layer MPLS network NW_{U}. Therefore, in the example of FIG. 1, the router R_{L}12 also sets up a similar TE-LSP with the router R_{U}1. Furthermore, the routers R_{L}21, R_{L}22 in the lower layer MPLS network NW_{L}2 are both to set up a different TE-LSP3 with the gateway router R_{U}2.

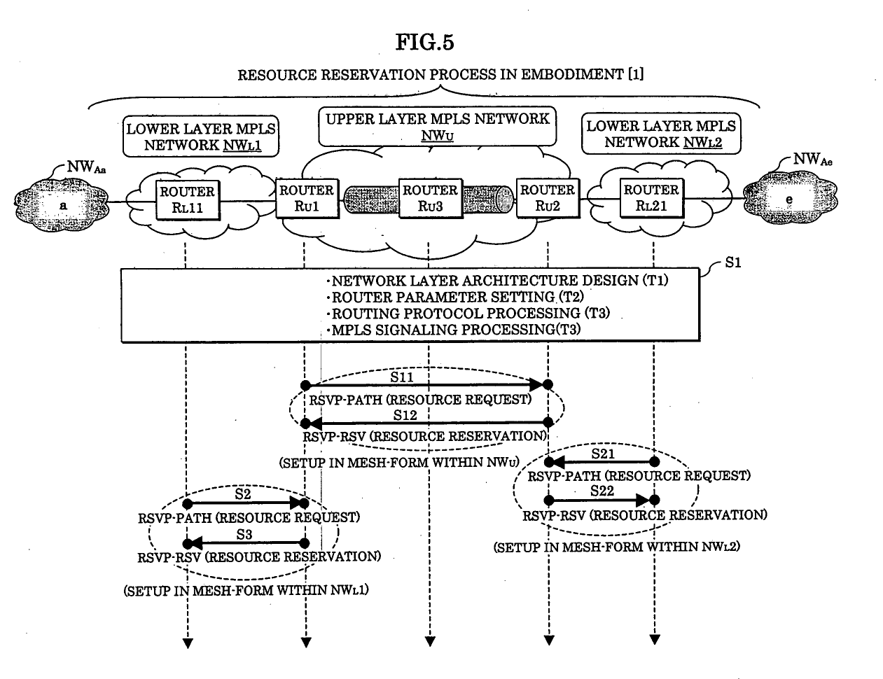

Such a resource reservation process (1) is shown in FIG. 5.

In the lower layer MPLS network NW_{L}1 in the example of FIG. 1, the edge router R_{L}11 makes a resource reservation request (RSVP-PATH) (step S2) by using e.g. RSVP-TE signaling protocol with the edge router R_{L}12 (not shown in FIG. 5), and the router R_{L}12 responsively makes a resource reservation (RSVP-RSV) (step S3), thereby reserving or securing a necessary resource. As a result, in the lower layer network NW_{L}1, TE-LSP's are set up in a full mesh form between the routers.

These resource request (RSVP-PATH) and resource reservation (RSVP-RSV) are also executed in the upper layer MPLS network NW_{U} as indicated by steps S11 and S12 for a mesh setup within the network. Also in the lower layer MPLS network NW_{L}2, the resource request (step S21) is similarly performed and the resource reservation (step S22) is responsively performed, thereby performing a mesh setup within the network.

It is to be noted that as shown in FIG. 5, prior to the resource request and the resource reservation the network layer architecture design (step T1), router parameter setting (step T2), routing protocol processing and MPLS signaling processing (step T3) are to be executed as described referring to FIG. 2 (step S1).

Step T5:

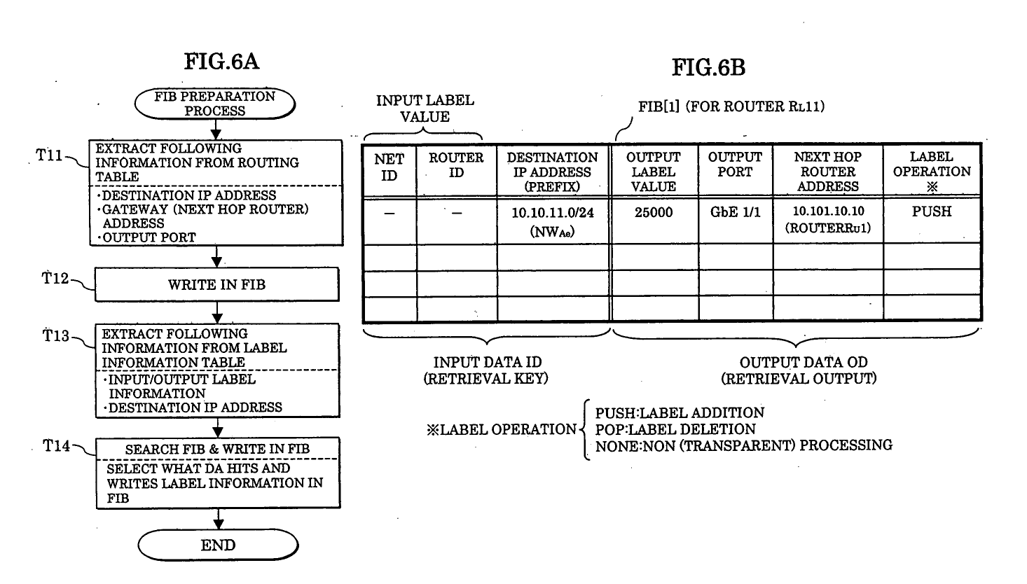

Next, the forwarding information table (FIB) 7 is prepared. The preparation process of the forwarding information table 7 is shown FIG. 6A. The FIB preparating processor 8 extracts “destination IP address”, “gateway (next hop router) address”, and “output port” from the routing table 5 (step T11), and writes them in the forwarding information table 7 (step T12). Then, from the label information table 6 already prepared, the FIB preparating processor 8 extracts “input/output label information (value)” and “destination IP address” (step T13), retrieves the table 7, selects what the destination IP address hits, and writes the label information in the table 7 (step T14).

As a result, as shown in the table arrangement [1] in FIG. 6B, in the example of the router R_{L}11, it is connected to the access networks NW_{Aa}, NW_{Ab}, so that there exists no input label value and the destination access network NW_{Ae} having the destination IP address (prefix) “10.10.11.0/24” is to be set up with its input data ID. For the corresponding output data OD, output label value=25000, output port=GbE1/1, next hop router address=10.101.10.10 (router R_{U}1), and label operation=PUSH are set up. It is to be noted that “PUSH” of label operation indicates a label addition, “POP” indicates label deletion, and “NONE” indicates non processing or transparent processing except TTL subtraction.

Step T6:

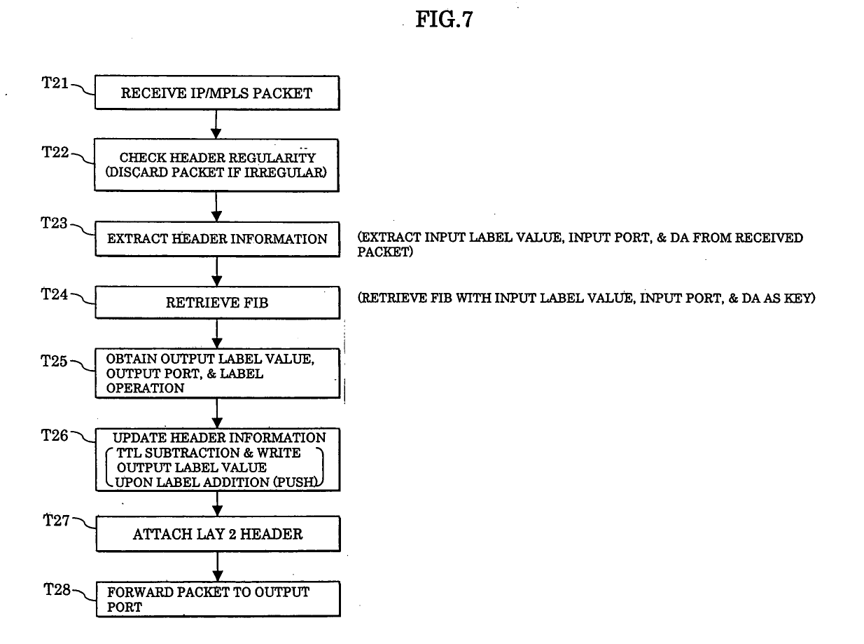

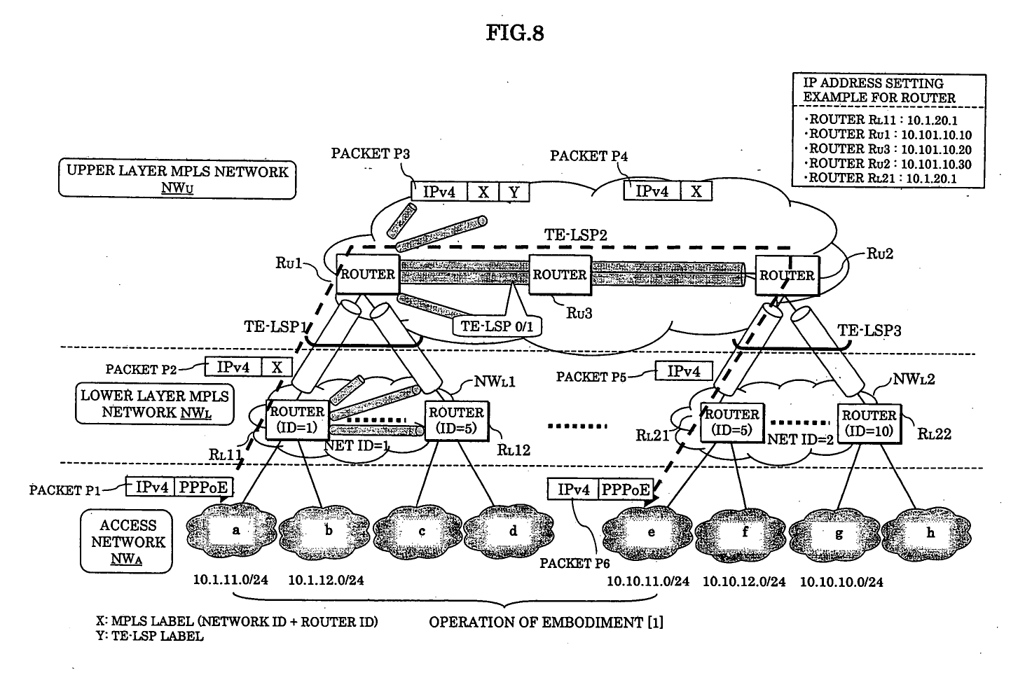

Then, packet transmission/reception processings are executed. The flow chart of this packet transmission/reception processing is shown in FIG. 7, which will be described referring to an operation example (1) shown in FIG. 8.

In the example of the router R_{L}11, when the IP/MPLS packet processor 11 receives a packet P1 from the access network NW_{Aa} such as ADSL network (step T21), a PPPoE header for example is extracted to check the legitimacy of the header (step T22), so that if it is found to be an illegal header, this packet is discarded. Then, from the received packet, as a header information (destination information), the input label value, input port, and destination IP address are extracted (step T23).

As shown in the forwarding information table [1] of FIG. 6B, it does not include a network ID and a router ID as the input label value. Only the destination IP address is shown as “10.10.11.0/24” (access network NW_{Ae}). Therefore, by the retrieval with the destination IP address as a key (step T24), the output label value=25000, output port=GbE1/1, and label operation=PUSH are obtained (step T25), so that the header information of the packet is accordingly updated (step T26). This is done by the TTL subtraction and writing the output label value. In the operation example (1) of FIG. 8, from the router R_{L}11 to an output port=GbE1/1 connected to the router R_{U}1 designated by the next hop router address “10.101.10.10” shown in the forwarding information table 7, a packet P2 in which a layer 2 header (shim header) X is added (step T27) is forwarded (step T28).

The router R_{U}1 having thus received the packet P2 is provided with the same table as the forwarding information table 7 shown in FIG. 6B, so that the router R_{U}1 extracts the network ID from the MPLS header X of the received packet P2 and forwards to the TE-LSP2 within the upper, layer MPLS network NW_{U} a packet P3 in which the packet P2 is added with the TE-LSP label Y The forwarding process from the router R_{U}1 to the router R_{U}2 through the next hop router R_{U}3 is a conventional label switching process, so that the next hop router R_{U}3 removes the label Y from the packet P3 to be forwarded to the router R_{U}2 as a packet P4. The router R_{U}2 extracts the router ID from the MPLS header of the received packet P4, and forwards it as a packet P5 to the router R_{L}21 in the lower layer network NW_{L}2 through the TE-LSP3 previously set up. The packet P5 is forwarded as a packet P6 to the destination access network NW_{Ae} through the router R_{L}21.

Such a packet forwarding process enables the resource to be guaranteed from end to end, resulting in an advantage that the upper layer and the lower layer can be separately designed for the resources.

### Embodiment [2] (for Problem 1)

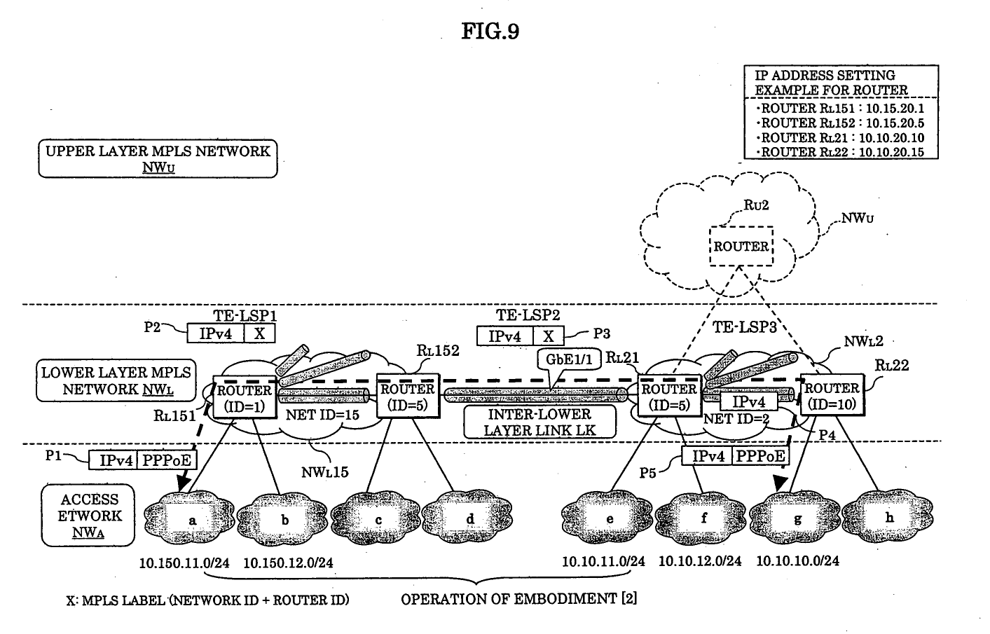

While in the above embodiment [1], when a packet is transmitted from the access network NW_{Aa} to NW_{Ae}, it has been forwarded from the lower layer MPLS network NW_{L}1 through the upper layer MPLS network NW_{U} to the lower layer network NW_{L}2, there is a case where the lower layer network NW_{L} is not always required to be connected to the upper layer MPLS network NW_{U} for the packet forwarding. This is a case where when a packet is forwarded through the lower layer MPLS networks NW_{L}15 and NW_{L}2 as intervening between the lower layer networks NW_{L}1 and NW_{L}2 in FIG. 8, as shown in FIG. 9, a direct packet forwarding should be made from the lower layer MPLS network NW_{L}15 to the network NW_{L}2 other than the packet forwarding through the upper layer MPLS network NW_{U} because both former networks are geographically near. This also applies to a case where there does not occur a traffic to such an extent as to pass through the upper layer network of a high speed and a large capacity.

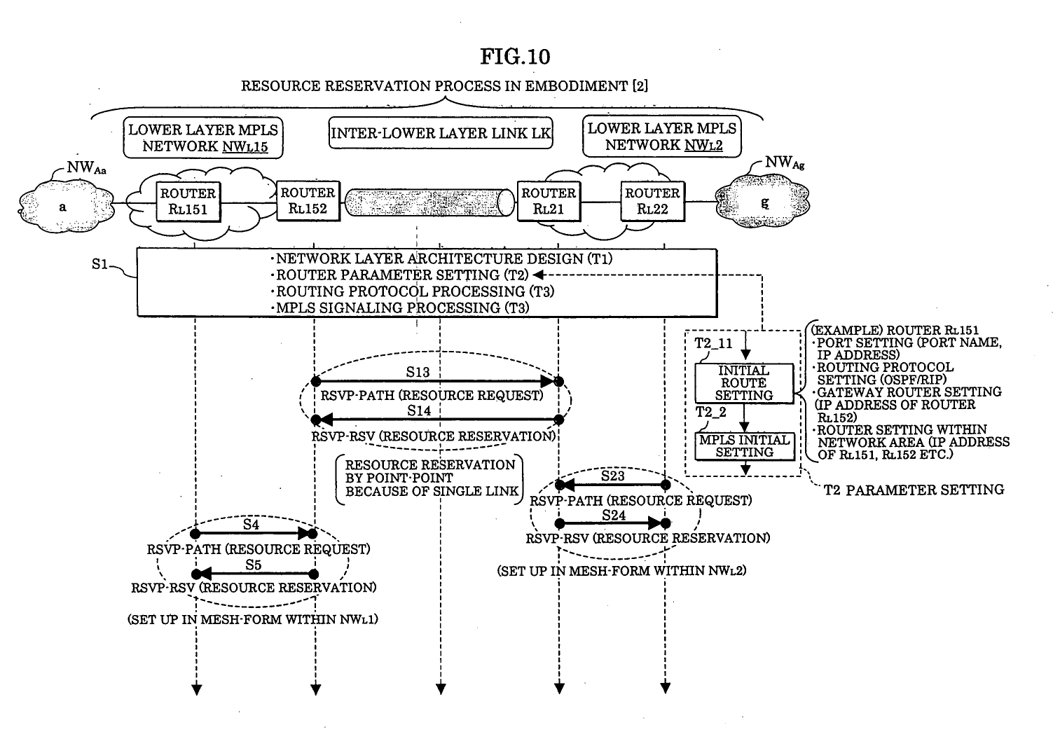

A resource reservation process for this case is shown FIG. 10. In this process, a router in each layer MPLS network performs, as in the above, the network layer setting (step T1), router parameter setting (step T2), routing protocol processing (step T3), and MPLS signaling processing (step T3) (step S1).

However, in this process (2), parameter settings different from the embodiment [1] are performed for the router parameter settings at step T2. Namely, in case of a router R_{L}151 in a lower layer network NW_{L}15, for a route initial setting (step T2_11), port settings for the port name and the IP address are performed, the routing protocol settings for OSPF or IS-IS are performed, and gateway router settings are performed. As a gateway router of this case, it corresponds to a router R_{L}152 in the same lower layer MPLS network NW_{L}15 so that the IP address of the router R_{L}152 is set up for the gateway router. Namely, the router R_{L}152 within the same domain is set up for the gateway router whereby it is found that the lower layer networks are applied. Then, the IP addresses of the routers R_{U}151, R_{L}152 and the like are set up for the routers within the network.

Then, the MPLS initial settings (step T2_2) are performed where the MPLS initial settings are entirely the same as the MPLS initial settings shown in FIG. 2.

After this, as in the case of FIG. 5, TE-LSP's are set up in a mesh form between the routers in each network within the lower layer MPLS network NW_{L} (step S4, S5). In order to set up a link (TE-LSP) LK between the routers of the lower layers, e.g. the gateway router R_{L}152 in the lower layer network NW_{L}1 and a gateway router R_{L}21 in the lower layer MPLS network NW_{L}2, a resource request is made (step S13), and in response the router R_{L}31 makes a resource reservation, where the link is single so that the resource reservation is performed from point to point. Then similarly in the lower layer MPLS network NW_{L}2, the resource request (step S23) and a resource reservation (step S24) are made to set up TE-LSP's in a mesh form between the routers.

As a result, by mutually connecting the TE-LSP's within those lower layers, a path for guaranteeing the resource from end to end between the access networks NW_{Aa} and NW_{Ag} is provided.

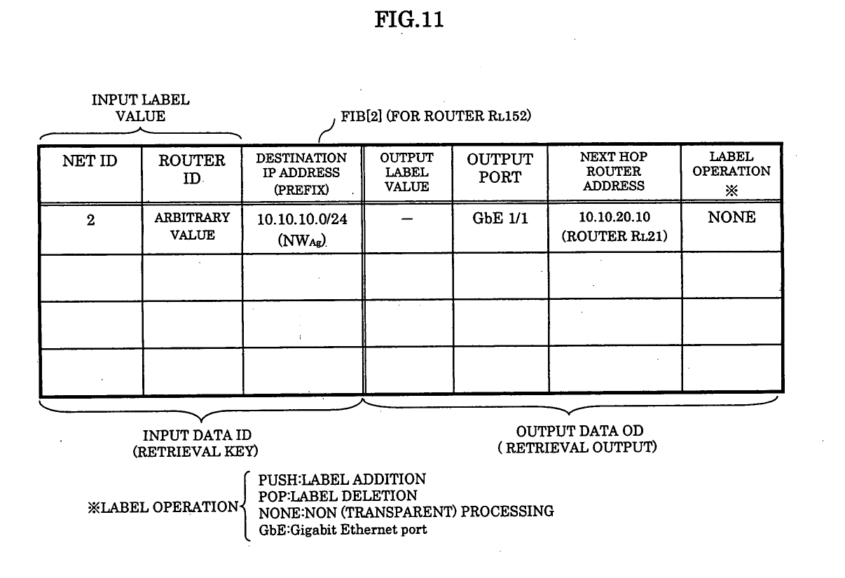

FIG. 11 shows an arrangement [2] of the forwarding information table 7 in the router R_{L}152 which is a gateway router of the lower layer network NW_{L}15 for example. This is utilized in the operation example of FIG. 9 as follows:

Namely, when the packet P1 is provided to the router R_{L}151 in the lower layer MPLS network NW_{L}15 from the access network NW_{Aa}, the packet P2 added with the MPLS label X is provided to the router R_{L}152 from the router R_{L}151. Since the forwarding information table 7 in the router R_{L}152 indicates, as shown in FIG. 11, that the packet P2 is directed to the access network NW_{Ag} if the network ID=2 and the destination IP address=10.10.10.0/24 in the input label value even though the router ID is arbitrary, it is found that the next hop router is the router R_{L}21 having the IP address 10.10.20.10 by retrieving the forwarding information table 7, so that the packet P3 is to be forwarded to the gateway router R_{L}21 in the opponent lower layer network NW_{L}2 through the link LK from the output port GbE1/1. Since the router R_{L}21 knows that the destination is the access network NW_{Ag}, the router R_{L}21 transfers the packet P4 to the gateway router R_{L}22 connected to the access network NW_{Ag}. The gateway router R_{L}22 transfers the packet P5 the header of which is added with PPoE to the access network NW_{Ag} as the destination.

Label Information Switching

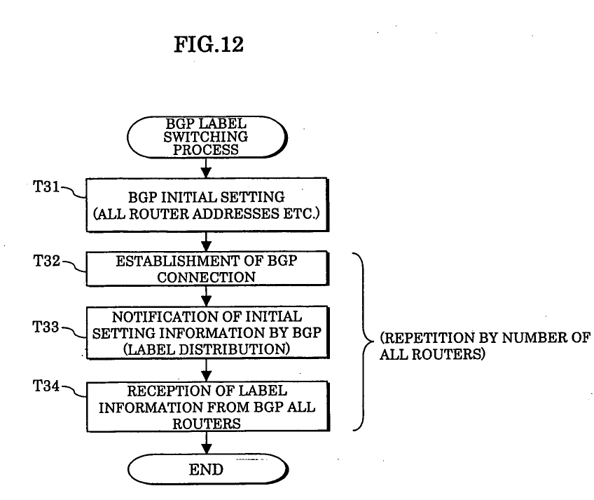

While the above-mentioned MPLS signaling protocol processing (step T3) in FIG. 2 includes a manual setting or BGP setting or label server setting as setting means of label information switching in the MPLS initial setting (step T2_2), a label information switching by means of BGP processing as one example will be described. A label switching example (1) of this case is specifically shown in FIG. 12.

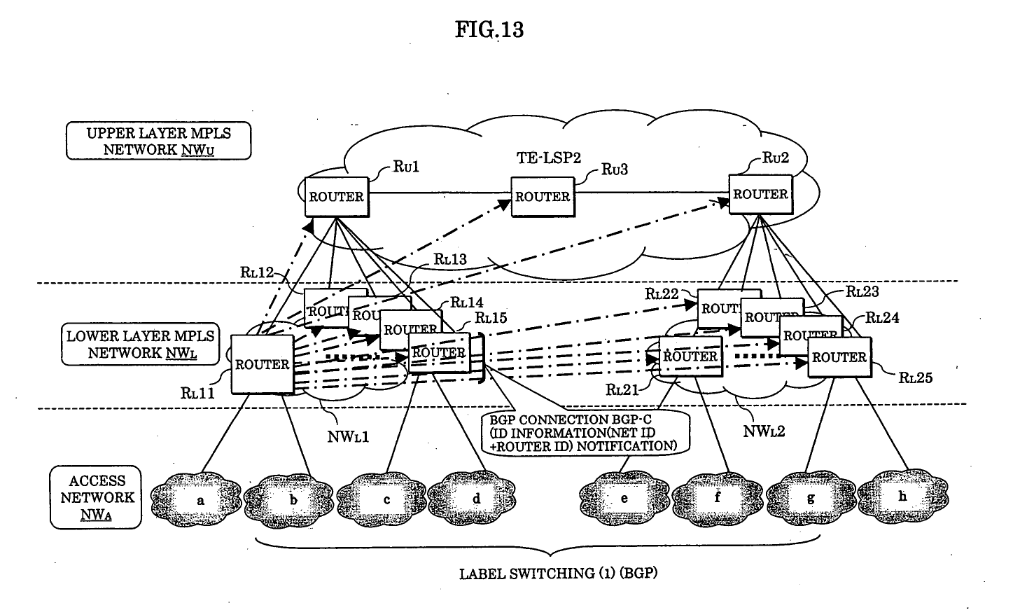

At a BGP initial setting, a network ID and a router ID in all of the routers are set up (step T31), which is done by an operator's manual work. Specifically, as shown in the label information switching example (1) of FIG. 13, a network ID and a router ID in the upper layer MPLS network NW_{U} and the lower layer MPLS network NW_{L} are manually and initially preset.

Then, in the example shown in FIG. 13, the router R_{L}11 in the lower layer MPLS network NW_{L} for example is turned on, a BGP connection BGP-C is established for all of the routers in all other layer networks (step T32), and the label information of the router R_{L}11 subject to BGP initial setting is distributed to all of the routers (step T33). The MPLS signaling protocol processor 10 in each router responsively returns its own label information, so that the router R_{L}11 is to receive the label information of all other routers (step T34). This process is repeated for all of the routers. It is to be noted that while in FIG. 13, arrows indicated by alternate long and short dashed lines are shown from the router R_{L}11 to other routers, arrows of the opposite direction from other routers to the router R_{L}11 are omitted.

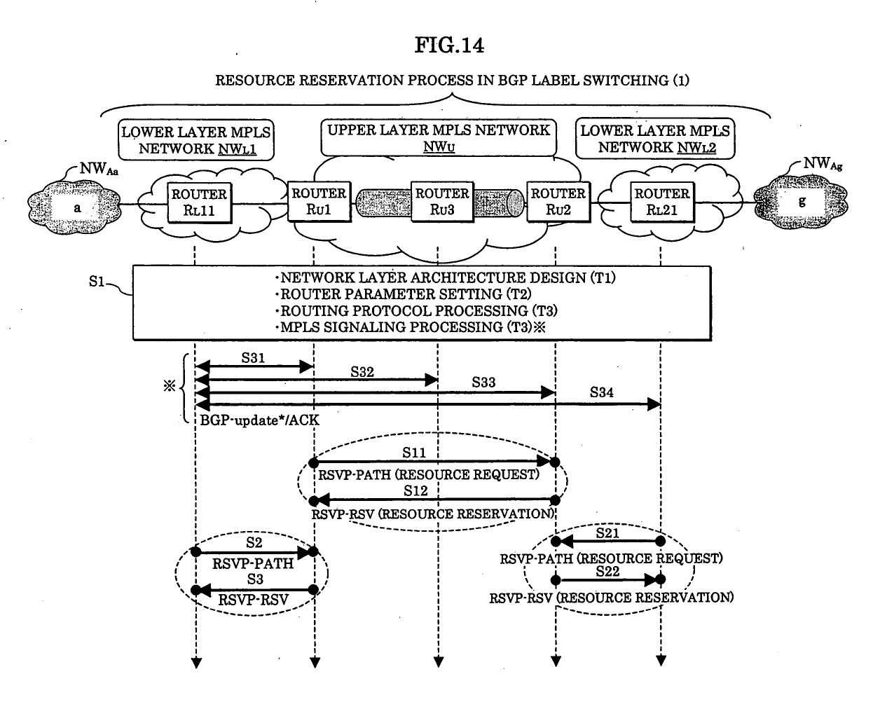

A resource reservation sequence of the label information switching example (1) shown in FIG. 13 is shown in FIG. 14.

As shown in FIG. 13, the router R_{L}11 performs the BGP signaling protocol for the router R_{U}1 in the upper layer MPLS network NW_{U} to switch the label information (BGP-update: step S31), performs BGP label information switching (BGP-update: step S32) for the router R_{U}3 in the same upper layer MPLS network NW_{U}, performs a BGP label information switching (BGP-update: step S33) for the router R_{U}2, and performs BGP label information switching for the router R_{L}21 in the lower layer MPLS network NW_{L}2 (BGP-update: step S34).

After this, the same resource reservation process (steps S2, S3, S11, S12, S21, S22) as in FIG. 5 are to be executed.

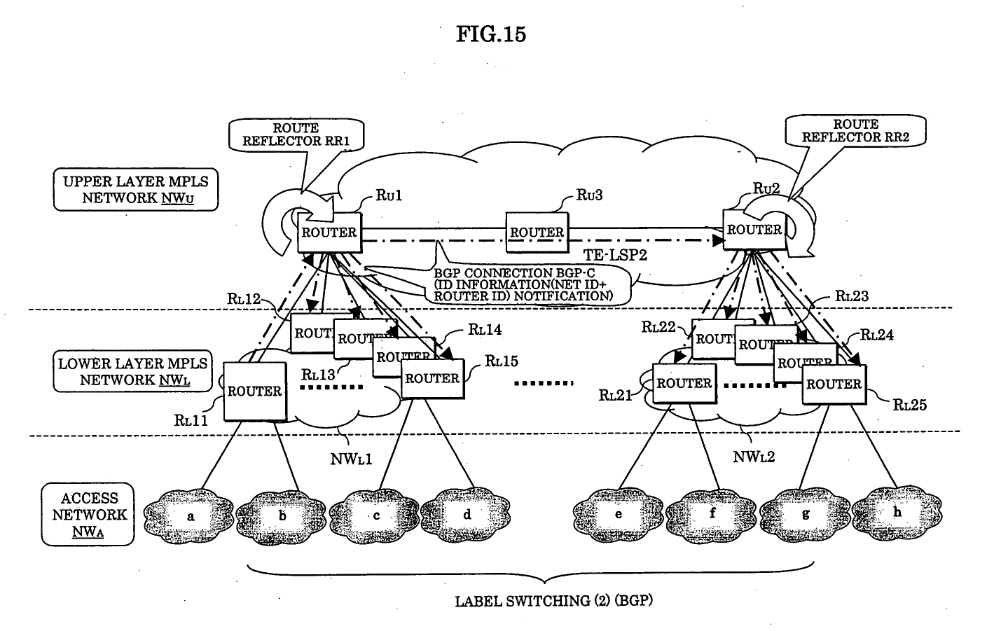

As above described, the label switching example (1) in FIGS. 13 and 14 is based on the BGP processing from one router to all other routers. While in case of a label information switching example (2) shown in FIG. 15 the same BGP processing is applied, the BGP processing is performed by route reflectors RR1, RR2 respectively provided in the gateway routers R_{U}1, R_{U}2 in the upper layer MPLS network NW_{U}. Namely, the label information from the router R_{L}11 is distributed with the BGP connection BGP-C to the routers R_{U}12-R_{U}15 in the lower layer MPLS network NW_{L}1 subordinate to the gateway router R_{U}1 provided with the router reflector RR1. Together with this, the BGP connection BGP-C is set up for the routers R_{U}3 and R_{U}2 so that the label information is also distributed to the routers R_{U}3, R_{U}2 in the upper layer MPLS network NW_{U} through the router reflector RR1 in the router R_{U}1. Furthermore, the label information is distributed to the routers R_{U}21-R_{U}25 in the lower layer MPLS network NW_{L}2 subordinate to the router R_{U}2 through the route reflector RR2 provided in the router R_{U}2.

As a result, mere communications between the router R_{L}11 and the gateway router R_{U}2 enable the label information concerning all of the routers to be obtained.

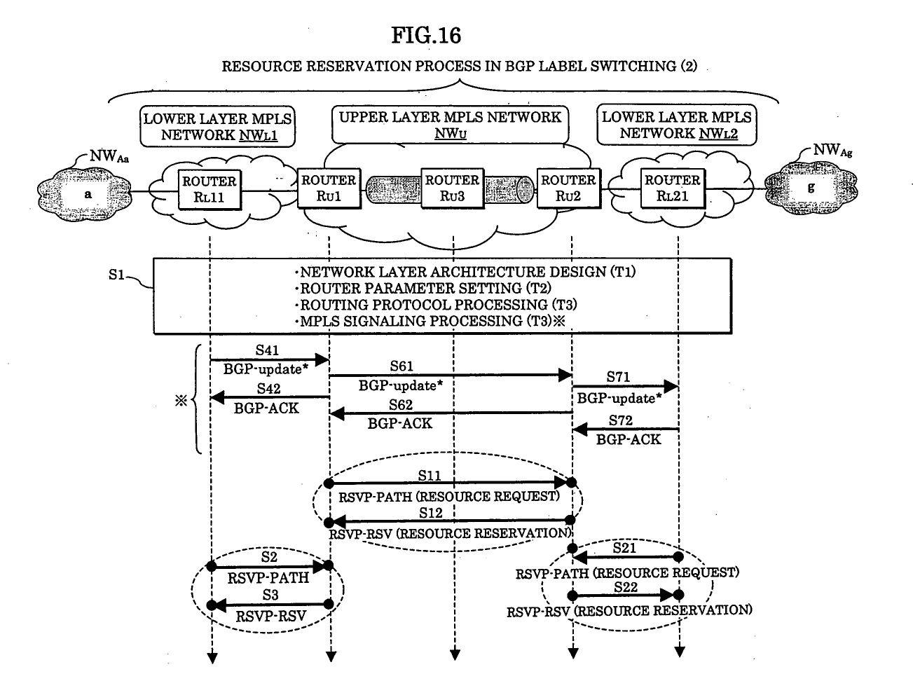

FIG. 16 shows a resource reservation process upon performing the label information switching example (2) thus using the reflectors, where the difference between this label information switching process and that shown in FIG. 14 is a portion shown by ※ mark. It is to be noted that FIG. 16 only shows processing upon distributing the label information from the router R_{L}11 to the router R_{L}21 for the simplification of the drawing.

When the router R_{L}11 performs the BGP processing (BGP-update: step S41), the router R_{U}1 returns the BGP response (BGP-ACK: step S42) and besides distributes the label information to the routers within the lower layer network NW_{L}1 and the router R_{U}2 (step S61). This makes it possible to obtain the label information from the router R_{U}2 (step S62), to perform label distribution to the routers R_{L}21 and other routers in the lower layer network NW_{L}2 through the route reflector RR2 provided in the router R_{U}2 (step S71), and to return the label information of the router R_{L}21 to the R_{U}2 (step S72) to be transmitted to the router R_{L}11 through the router R_{U}1.

After thus switching the label information, a resource reservation processing by means of RSVP-TE protocol or the like as in the above is carried out (steps S2, S3, S11, S12, S21, S22).

Thus, only with registering such reflectors, a maintenance person can save setting works for switching the label information.

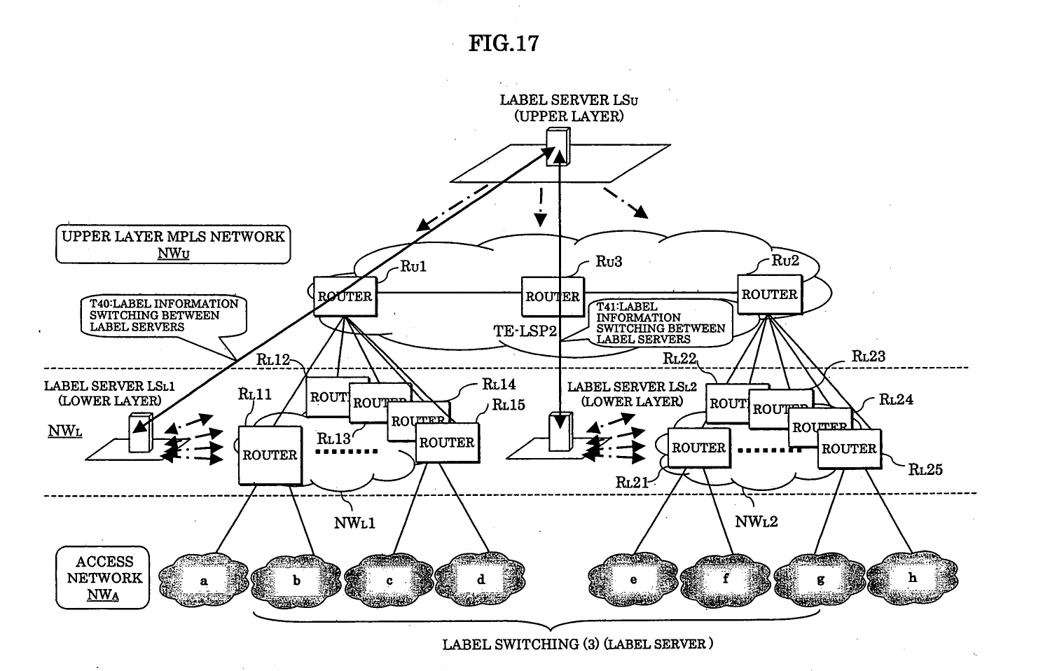

FIG. 17 shows a label information switching example (3), that is characterized by using a label server. Specifically, the upper layer MPLS network NW_{U} is provided with a label server LS_{U}, the lower layer MPLS network NW_{L} is provided with a label server LS_{L}1 for the network NW_{L}1, and a label server LS_{L}2 for the network NW_{L}2, respectively.

The label server LS_{U} acquires the label information from all of the routers such as routers R_{U}1-R_{U}3 existing in the subordinate network NW_{U}. The label server LS_{L}1 acquires the label information from all of the routers such as routers R_{L}11-R_{L}15 included in the subordinate network NW_{L}1. Also the label server LS_{L}2 acquires the label information from all of the routers such as routers R_{L}21-R_{L}25 in the subordinate network NW_{L}2.

Then, the label information acquired between the label servers is switched, and data synchronization is made to always update the label information. Namely, the label servers LS_{U} and LS_{L}1 mutually switch the label information at all times (step T40), and the label servers LS_{U} and LS_{L}2 also mutually switch the label information at all times (step T41).

As a result, each of the routers can obtain the label information within the network in its entirety.

It is to be noted that the label server is not necessarily provided for each network but for example the label server LS_{U} may perform a unitary management for all of the routers over the layers.

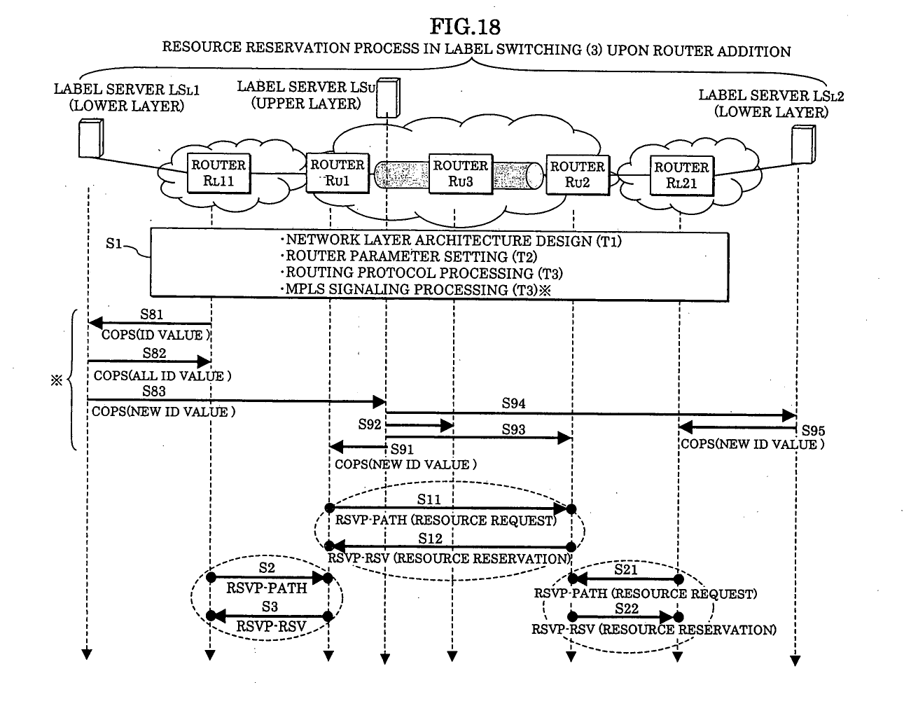

FIG. 18 shows, in the label information switching example (3) of FIG. 17, the process of label information switching and resource reservation when a new router is added. When the added router R_{L}11 is activated, after various settings shown at the above-noted step S1, the label information possessed by the router R_{L}11 is distributed to the label server LS_{L}1 (step S81). This is done by for example COPS, where this embodiment is not limited to this COPS but is applicable to various protocols such as SNMP.

The label server LS_{L}1 recognizes that the router R_{L}11 has been newly added, and distributes the label information of all of the routers which has been already acquired so far to the router R_{L}11 (step S82). Concurrently, the label server LS_{L}1 transmits the label information of the new router R_{L}11 to the label server LS_{U} to notify the label information to other networks (step S83). In response, the label server LS_{U} distributes the label information to the subordinate routers R_{U}1-R_{U}3 and the like (steps S91-S93). Concurrently, the label information is distributed also to the label server LS_{L}2 in a different network (step S94). The label server LS_{L}2 notifies the label information to all of the routers such as the subordinate router R_{L}21.

As a result, it becomes possible to distribute the label information of the newly added router R_{L}11 to all of the routers. The router R_{L}11 can also acquire the label information of all other routers. After thus switching the label information, a resource reservation processing by means of a protocol such as RLVP-TE is executed as in the above (steps S2, S3, S11, S12, S21, S22).

### Embodiment [2] (for Problem 2)

The above-described MPLS network according to the present invention is hierarchized into a plurality of layers, thereby forming a scalable MPLS network that is a network capable of reducing the number of TE-LSP's set up for the network.

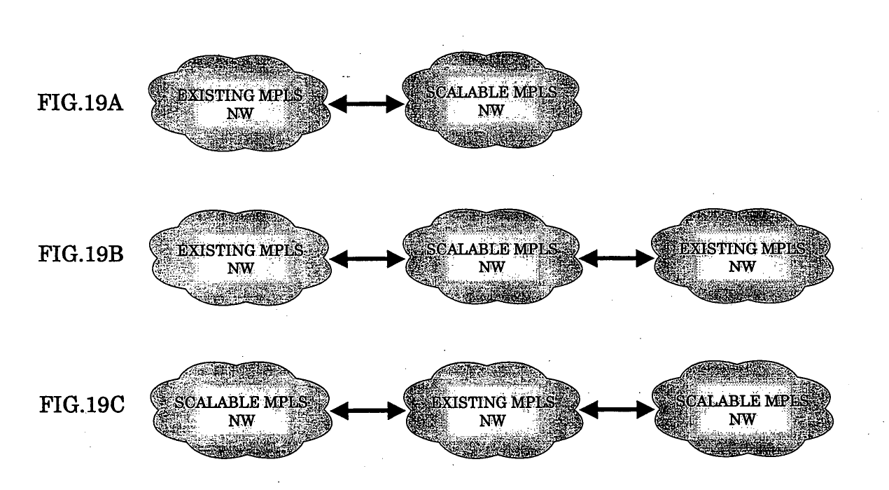

Patterns at the time of mutually connecting such a scalable MPLS network with a presently existing MPLS network are shown in FIG. 19A-19C, in either one of which a resource guarantee is required to be realized.

FIG. 19A shows a case where an existing MPLS network is connected to a scalable MPLS network according to the present invention. FIG. 19B shows a case where the scalable MPLS according to the present invention is connected to be sandwiched between existing MPLS networks. FIG. 19C shows a case where an existing MPLS network is connected to be sandwiched between the scalable MPLS networks according to the present invention.

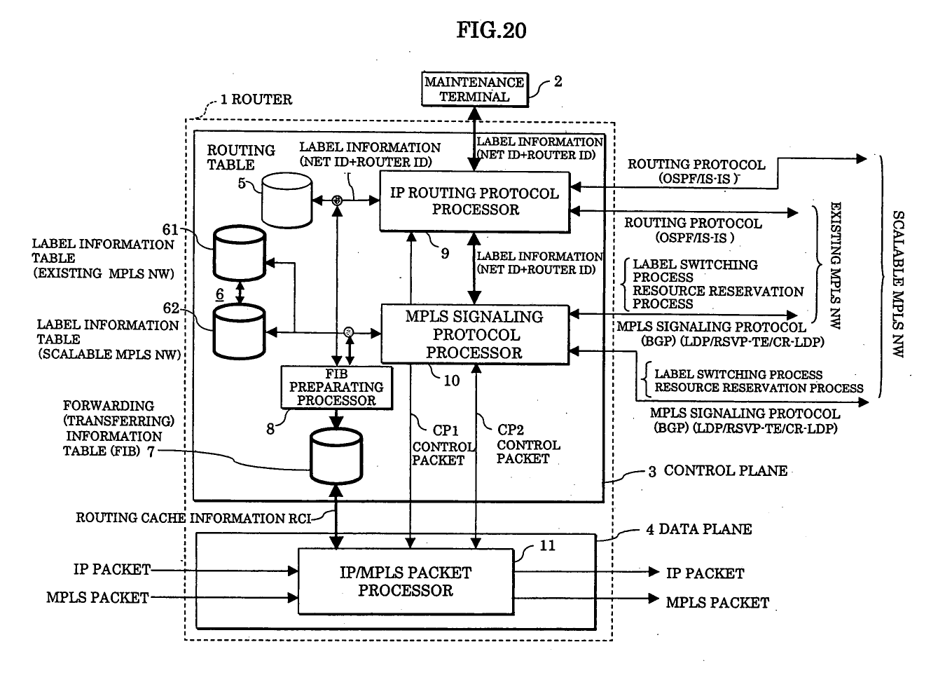

FIG. 20 shows a router arrangement [2] used for the pattern where the scalable MPLS network and the existing MPLS network are mutually connected as shown in FIG. 19A. As compared with the router arrangement [1] shown in FIG. 3, this router arrangement is characterized by the label information table 6 comprising a label information table 61 for the existing MPLS network and a label information table 62 for the scalable MPLS network. The IP routing protocol processor 9 and the MPLS signaling protocol processor 10 are connected to not only the scalable MPLS network according to the present invention but also the existing MPLS network to perform the routing protocol and the resource reservation processing, respectively.

Hereinafter, there will be described a setup process of a resource-guaranteed TE-LSP in patterns where the scalable MPLS network and the existing MPLS network are mutually connected as shown in FIGS. 19A-19C.

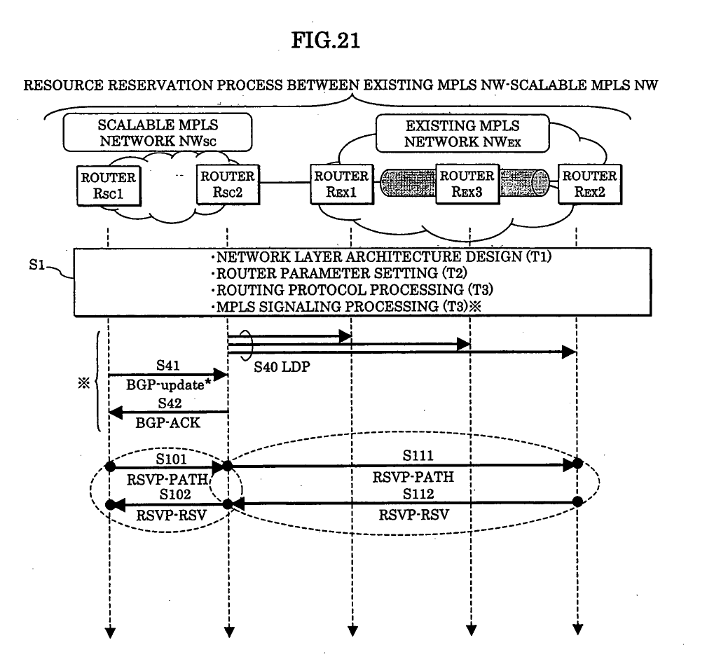

(1) Resource Reservation Process Between Existing MPLS NW-Scalable MPLS NW: FIG. 21

At first, each of the routers provided in each of the networks executes various initial settings shown at step S1 as in the above. Then, from a gateway router R_{SC}2 provided in the scalable MPLS network NW_{SC} according to the present invention and previously designated as an edge router to routers R_{EX}1-R_{EX}3 and the like provided in the existing MPLS network NW_{EX}, the label information (which is a label value of the shim header shown in FIG. 4, not network ID+router ID) is switched by a conventionally known LDP processing using an MPLS label (step S40).

This makes the gateway router R_{SC}2 learn the respective conventional label information of the routers R_{EX}1-R_{EX}3 in the existing MPLS network NW_{EX}, so that upon receipt of a label information request (BGP-update) from the router R_{SC}1 (step S41), the gateway router R_{SC}2 returns its response (BGP-ACK: step S42) as well as its own label information, but does not return the acquired label information of the routers R_{EX}1-R_{EX}3.

Since the router R_{SC}1 has already recognized by the routing protocol processing (step T3) that the router R_{SC}2 is a gateway router provided on the border with the existing MPLS network NW_{EX} and the router R_{EX}2 requiring a TE-LSP to be set up is positioned within the existing MPLS network NW_{EX}, when the router R_{SC}1 sets up a TE-LSP with the router R_{SC}2 by a conventional signaling protocol such as RSVP-TE (steps S101, S102), the router R_{SC}2 sets up a TE-LSP with the gateway router R_{EX}2 in the corresponding existing MPLS network NW_{EX} by a conventional signaling protocol such as RSVP-TE (steps S111, S112).

Thus, it becomes possible to set up a resource-guaranteed TE-LSP from end to end without consciousness of the existing MPLS network as seen from the scalable MPLS network.

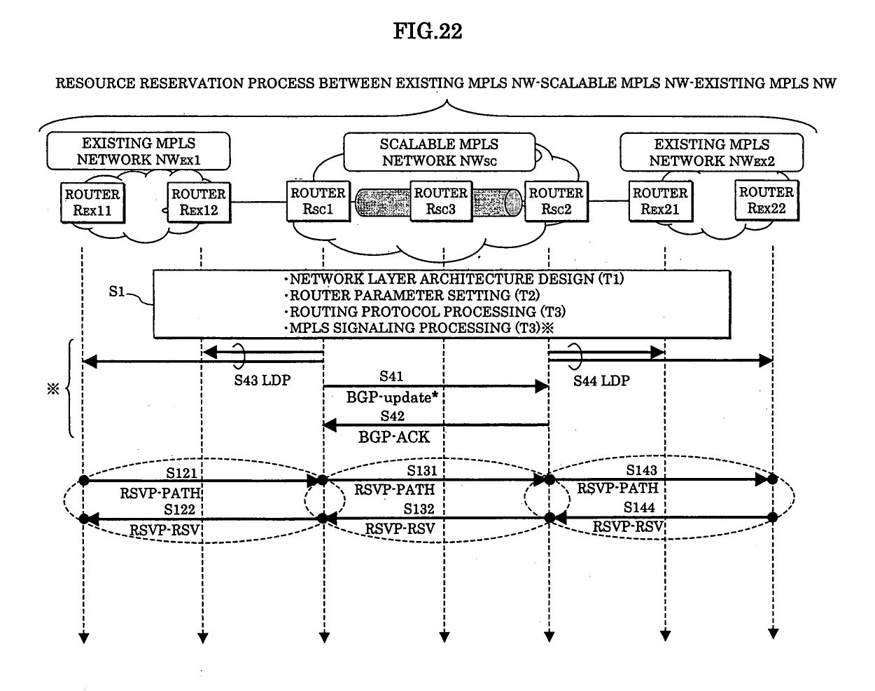

(2) Resource Reservation Process Between Existing MPLS NW-Scalable MPLS NW-Existing MPLS NW: FIG. 22

In this case from the gateway router R_{SC}1 provided on the border with the scalable MPLS network NW_{SC} according to the present invention to the routers R_{EX}11, R_{EX}12 in the existing MPLS network NW_{EX}1 in the same manner as the pattern in FIG. 21, label switching is performed by LDP that is a conventional label information switching protocol (step S43). Similarly, the gateway router R_{SC}2 located on the border of the opposite side performs label switching by the LDP processing to the routers R_{EX}21, R_{EX}22 in the existing MPLS network NW_{EX}2 connected to the gateway router R_{SC}2 (step S44). Within the scalable MPLS network NW_{SC}, the router R_{SC}1 performs label switching to all of the routers within the scalable MPLS network by the above-mentioned BGP processing (steps S41, S42).

When a TE-LSP setup request to the router R_{EX}22 in the existing MPLS network NW_{EX}2 is made from the router R_{EX}11 in the existing MPLS network NW_{EX}1 to the gateway router R_{SC}1 in the scalable MPLS network NW_{SC} (step S121), the router R_{SC}1 makes a resource reservation (step S122), sets up a TE-LSP to the other gateway router R_{SC}2 (steps S131, S132), and sets up a TE-LSP to the router R_{EX}22 in the existing MPLS network NW_{EX}2 (steps S143, S144).

Between these networks, it becomes possible to set up a TE-LSP from end to end without consciousness of the scalable MPLS network as seen from the existing MPLS network.

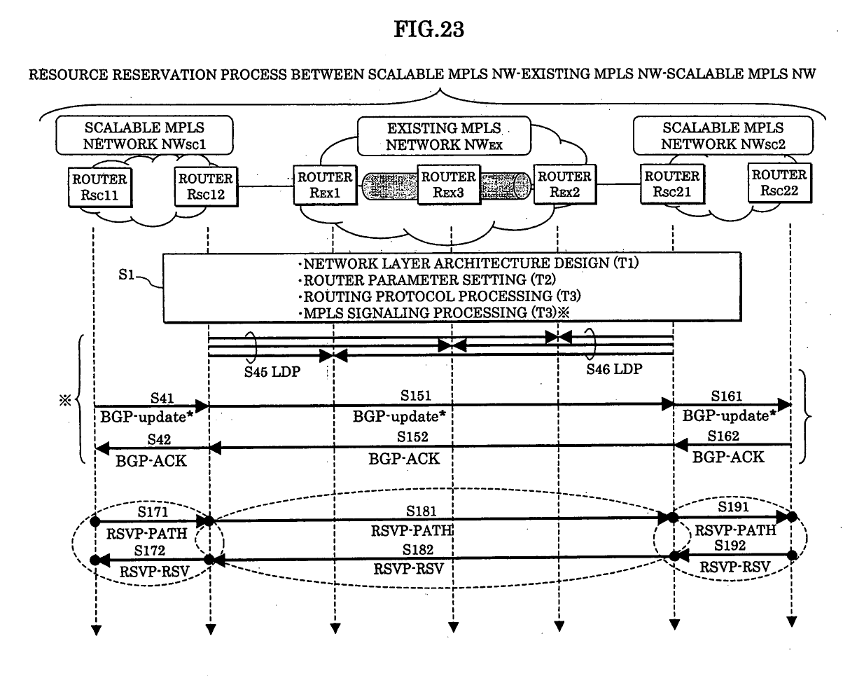

(3) Resource Reservation Process Between Scalable MPLS NW-Existing MPLS NW-Scalable MPLS NW: FIG. 23

Also in this pattern, label switching is made by the LDP protocol which is a conventional label switching protocol from the router R_{SC}12 provided on the border with the existing MPLS network NW_{EX} to the routers R_{EX}1-R_{EX}3 and the like in the existing MPLS network NW_{EX} (step S45). This applies to the gateway router R_{SC}21 in the scalable MPLS network NW_{SC}2, from which label switching is similarly made by the LDP processing to the routers R_{EX}1-R_{EX}3 and the like in the existing MPLS network NW_{EX} (step S46). Thus, the routers R_{SC}12, R_{SC}21 can acquire the label information of the routers within the existing MPLS network.

Having received a BGP label information switching request to the router R_{SC}22 from the router R_{SC}11, the router R_{SC}12 performs label switching with the router R_{SC}11 (steps S41, S42), and performs label switching with the router R_{SC}21 in the scalable MPLS network NW_{SC}2 through the existing MPLS network NW_{EX} (steps S151, S152). Furthermore, the router R_{SC}21 performs label switching with the router R_{SC}22 (steps S161, S162). Having received a resource reservation request from the router R_{SC}11, the router R_{SC}12 sets up a TE-LSP having the same route as the label information switching (steps S171, S172, S181, S182, S191, S192).

Therefore, the router R_{SC}11 may switch the label information consisting of the network ID and the router ID used in the scalable MPLS network with the gateway router provided within the scalable MPLS network, so that it becomes possible to set up a TE-LSP from end to end without consciousness of the existing MPLS network as seen from the scalable MPLS network.

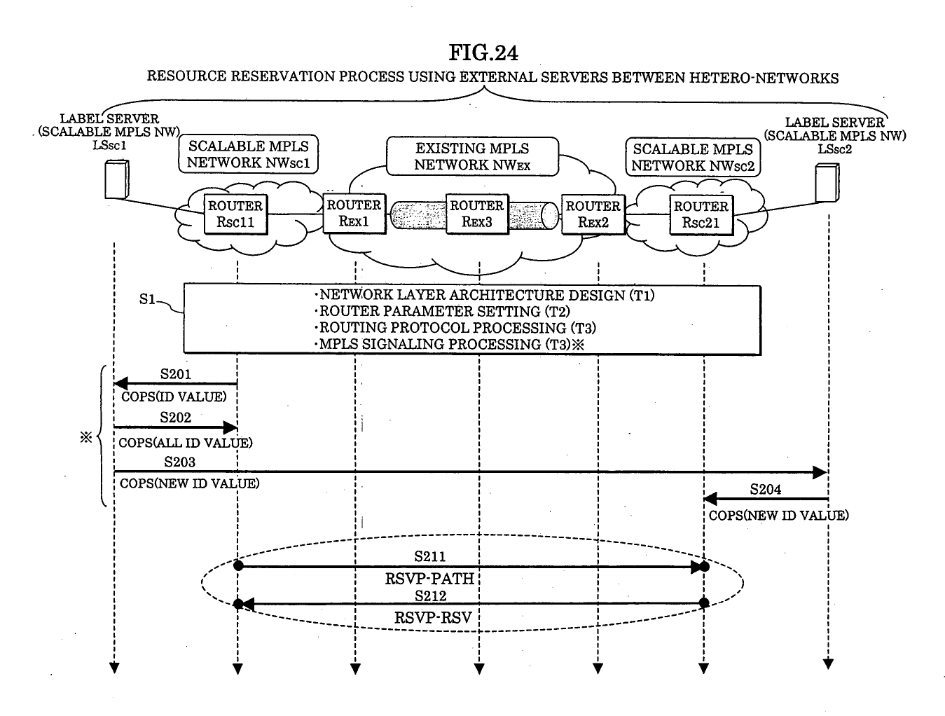

FIG. 24 shows label servers LS_{SC}1, LS_{SC}2 respectively provided for the scalable MPLS networks NW_{SC}1, NW_{SC}2 in the connection between hetero-networks shown in FIG. 23, in which the resource reservation is to take the same process as the label information switching example (3) using label servers shown in FIG. 18.

Namely, the label server LS_{SC}1 acquires the label information from all of the routers such as the router R_{SC}11 within the subordinate scalable MPLS network NW_{SC}1 (steps S201, S202). Also, the label server LS_{SC}2 similarly acquires the label information from the router R_{SC}21 and the like in the subordinate scalable MPLS network NW_{SC}2, which is not shown in the figure. Then, the label information acquired is switched between the label servers LS_{SC}1 and LS_{SC}2 (step S203) to synchronize the data so as to always update the label information. Accordingly, the label server LS_{SC}2 folds back and distributes the newly acquired label information to the subordinate router R_{SC}21 and the like (step S204).

As a result, it becomes possible for the router R_{SC}11 in the scalable MPLS network NW_{SC}1 to set up a TE-LSP with the router R_{SC}21 in the scalable MPLS network NW_{SC}2 (steps S211, S212).

In the end, it becomes possible for each of the routers to perform a resource reservation within the network even in the connection with the existing MPLS network.

### Embodiment [3] (for Problem 3)

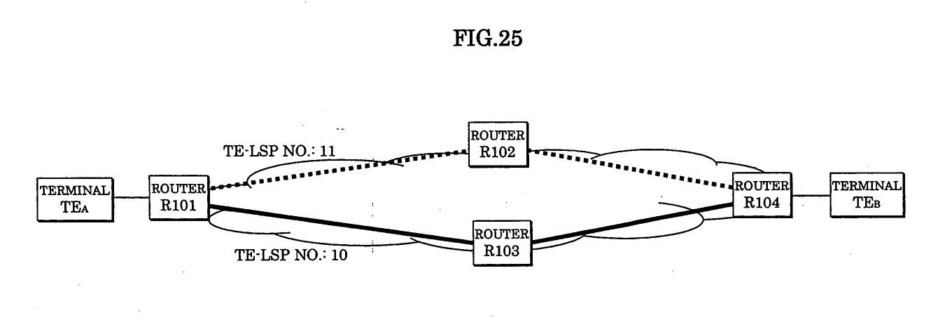

In the above various networks, when a TE-LSP from a terminal TE_{A} to a terminal TE_{B} is reserved or secured as shown in FIG. 25, a gateway router (egress router) R104 connected to the terminal TE_{B} has the same destination as seen from a router (ingress router) R101 connected to the terminal TE_{A}. The following various measures are conceived which enable the packet loss occurrence to be avoided by preparing at least two or more resource-guaranteed TE-LSP's (TE-LSP No. 10, 11) to the same destination gateway router and by utilizing the TE-LSP's which have been confirmed to be able to reserve the resource.

Hereinafter, it is supposed that the TE-LSP's to the same destination have the label information but are given different TE-LSP Nos.

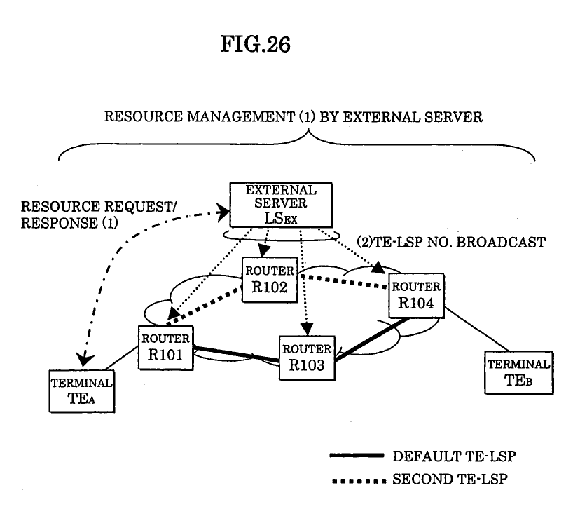

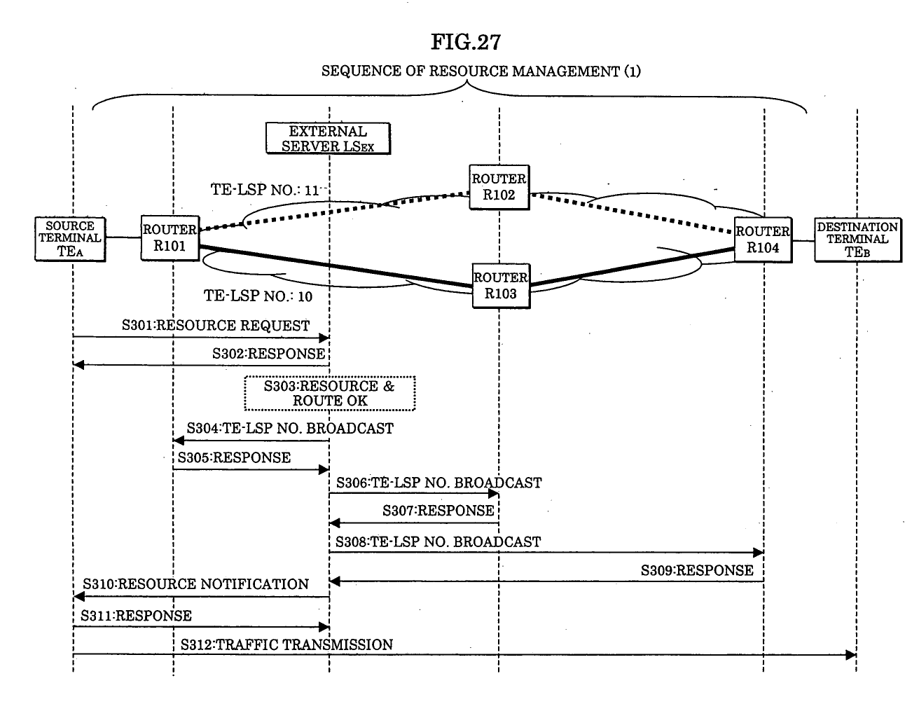

Resource Management Example (1): FIGS. 26 and 27

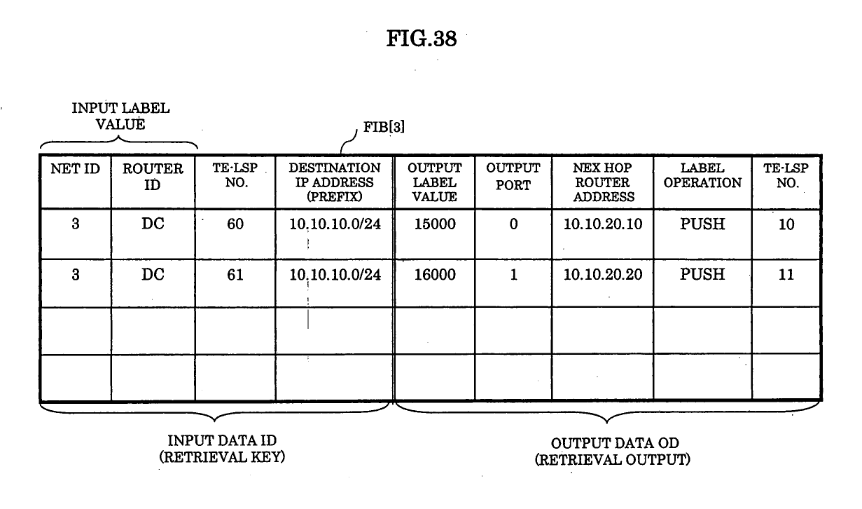

In FIGS. 26 and 27, it is supposed that two TE-LSP's, i.e. a default route (TE-LSP) shown by a solid line from the source terminal TE_{A} to the destination terminal TE_{B} through routers R101, R103, R104 and another TE-LSP shown by dotted lines through the routers R101, R102, R104 have been already set up, which will apply to the following. For traffic transmission/reception by utilizing TE-LSP, the source terminal TE_{A} makes a source request/response (1) to an external server LS_{EX} managing the resource (steps S301, S302 in FIG. 27). The external server LS_{EX} in response to the resource request specifies the corresponding TE-LSP with the MPLS input label value, TE-LSP No., and destination ID address being a key, from the destination IP address by referring the arrangement example [3] of the forwarding information table as shown in FIG. 38. This embodiment gives two TE-LSP's to the same destination terminal and assigns the respective TE-LSP's to at least different label values and output ports.

After having confirmed if the resource of each TE-LSP is excessive or lack from the destination IP address, the external server LS_{EX} determines, which TE-LSP should be applied (step S303). It is to be noted that since at first the default TE-LSP is selected, whether or not it should be changed over to another TE-LSP is determined. After the determination of the TE-LSP, the external server LS_{EX} performs a broadcast (2) of the TE-LSP No. to each of the subordinate routers R111-R104 (steps S304, S306, S308). After having received the TE-LSP No., each router returns the response to the external server LS_{EX} (steps S305, S307, S309). After having received the response from all of the routers, the external server LS_{EX} notifies to (receives from) the source terminal TE_{A} that the resource has been reserved (steps S310, S311), and the source terminal TE_{A} starts to transmit/receive the traffic (step S312). It is to be noted that the external server may be operated by being divided into a resource managing server and a proxy server which makes request response from the source terminal.

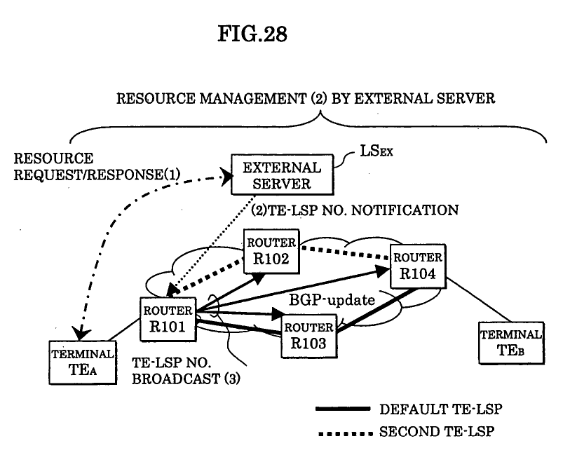

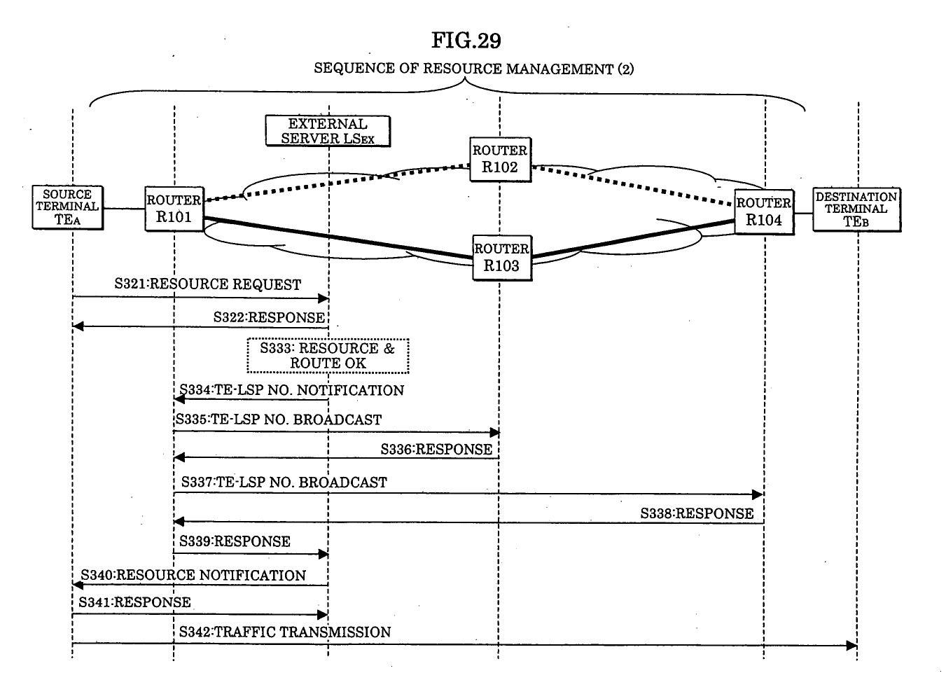

Resource Management Example (2): FIGS. 28 and 29

Also in this example, it is supposed like the above resource management example (1) that two TE-LSP's are set up so that the source terminal TE_{A} makes a source request/response (1) to the external server LS_{EX} (steps S321, S322 in FIG. 29). At first, the external server LS_{EX} determines which TE-LSP should be applied after having confirmed if the resource of each TE-LSP is excessive or lacking as in the above (step S333). In this example, the external server LS_{EX} then notifies the TE-LSP No. to an ingress router (LER: Label Edge Router) R101 in the MPLS network connected to the source terminal TE_{A} (step S334). The ingress router R101 in response to the notification performs a broadcast (3) of the TE-LSP No. by e.g. BGP protocol (BGP-update) to routers R102-R104 within the MPLS network (steps S335, S337).

The routers, R102-R104 in response to the TE-LSP No. returns a response to the ingress router R101 (steps S336, S338). After having received the response from all of the routers R102-R104, the ingress router R101 notifies to the source terminal TE_{A} that the resource has been reserved (step S340). After having returned the response to it (step S341), the source terminal TE_{A} starts to transmit/receive the traffic (step S342). Thus, it becomes possible to transmit/receive a traffic by utilizing resource-guaranteed TE-LSP's.

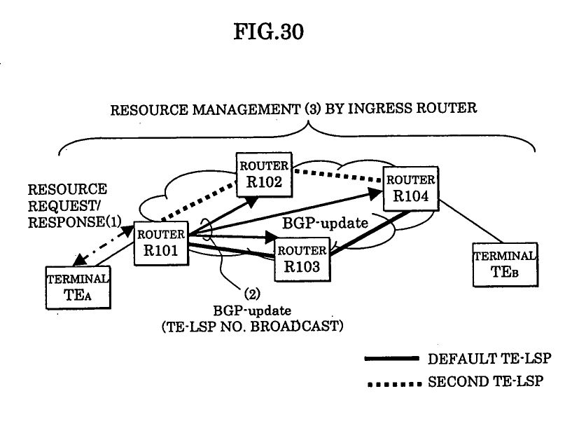

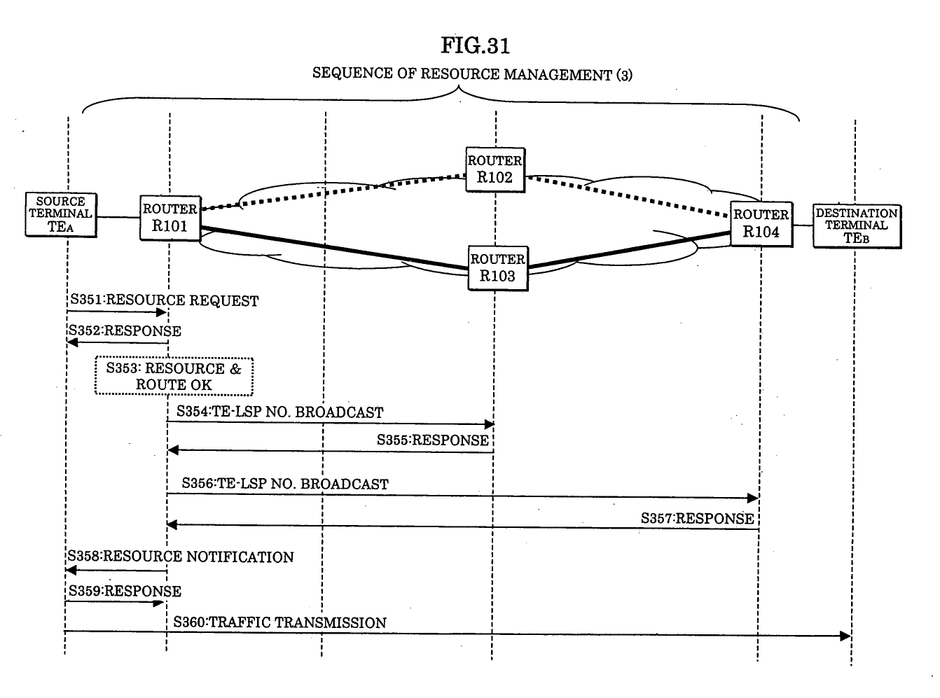

### Resource Management Example (3): FIGS. 30 and 31

Also in this case, it is supposed in the same manner as the above resource management examples (1) and (2) that a default TE-LSP and a second TE-LSP are set up. When the source terminal TE_{A} desires to transmit/receive a traffic by utilizing the TE-LSP, the source terminal TE_{A} exchanges a resource request/response (1) with the resource managing ingress router R101 (steps S351, S352 in FIG. 31). The ingress router R101 in response to the resource request specifies the corresponding TE-LSP route from the destination IP address like the above external server (step S353). The ingress router R101 performs a broadcast (2) of the TE-LSP No. by e.g. the same BG-update as the above to the routers R102-R104 within the MPLS network (steps S354, S356).

The routers R102-R104 having received the TE-LSP No. return a response to the ingress router R101 (steps S355, S357). After having received the responses from all of the routers R102-R104, the ingress router R101 notifies to the source terminal TE_{A} that the resource has been reserved (step S358), so that the source terminal TE_{A} responsively starts to transmit/receive the traffic (steps S359, S360). Thus, it becomes possible to transmit/receive such a traffic by utilizing the resource reserved TE-LSP.

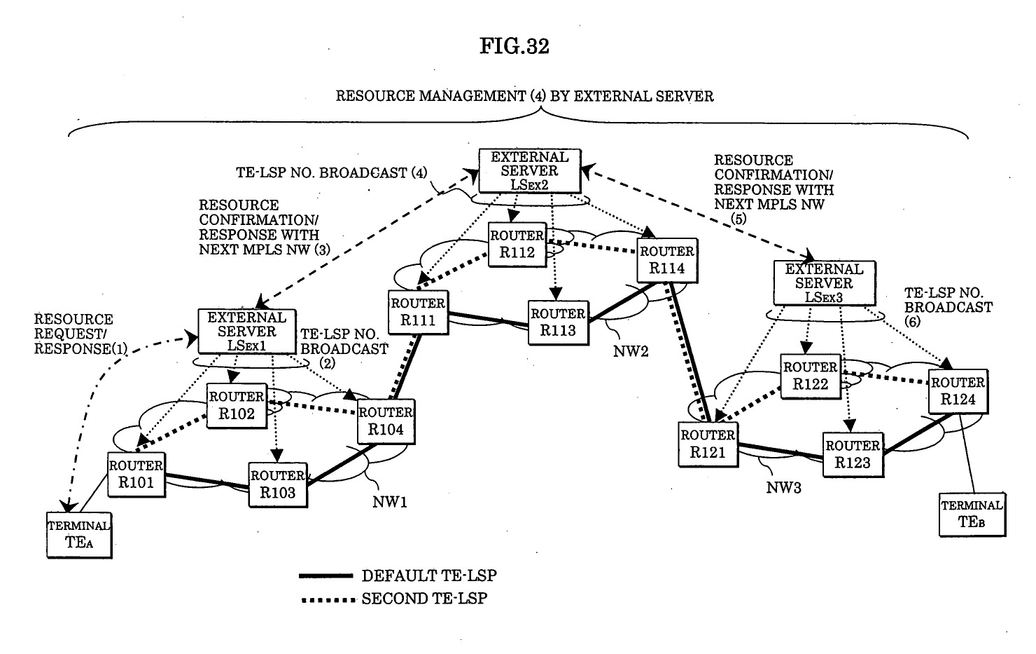

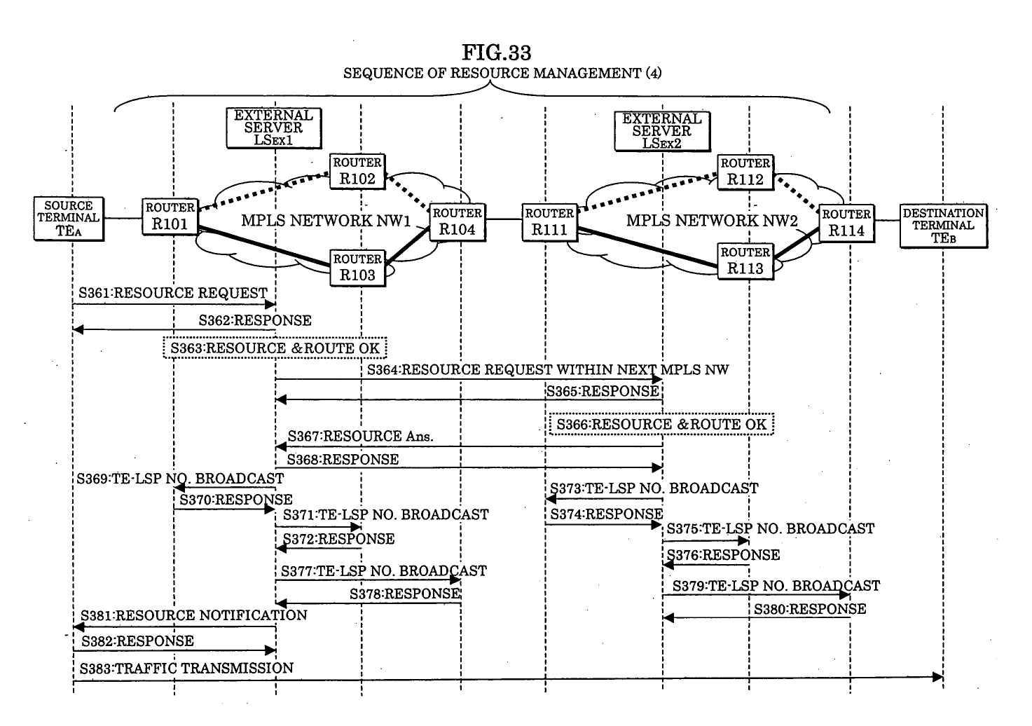

Resource Management (4): FIGS. 32 and 33

This resource management example is one which has expanded the resource management example (1) shown in FIGS. 26 and 27, in which external servers LS_{EX}1-LS_{EX}3 are provided respectively for three MPLS networks NW1-NW3. The source terminal TE_{A} is connected to the gateway router R101 of the MPLS network NW1, and the source terminal TE_{B} is connected to the gateway router R124 of the MPLS network NW3. The gateway router R104 in the network NW1 and the gateway router R111 in the network NW2 are mutually connected, and the gateway router R114 in the network NW2 and the gateway router R121 in the network NW3 are mutually connected.

For the routes toward the destination terminal TE_{B} from the source terminal TE_{A}, a default TE-LSP through the router R101→R103→R104 and a second TE-LSP through the router R101→R102→R104 are set up in the MPLS network NW1, a default TE-LSP through the router R111→R113→R114 and a second TE-LSP through the router R111→R112→R114 are set up in the MPLS network NW2, and a default TE-LSP through the router R121→R123→R124 and a second TE-LSP through the router R121→R122→R124 are set up in the MPLS network NW3. It is to be noted that in the sequence of FIG. 33, the MPLS network NW3 is omitted for the simplification of figure, however the concept is completely the same.

At the moment, when the source terminal TE_{A} desires to transmit/receive traffics the utilizing the TE-LSP, the source terminal TE_{A} exchanges a resource request/response (1) with the resource managing external server LS_{EX}1 (steps S361, S362). The external server LS_{EX}1 having received the resource request determines an optimum TE-LSP from the destination IP address as in the above (step S363). If the resource of the subordinate network NW1 is reserved, the external server LS_{EX}1 makes a resource inquiry (3) within the network to the external server LS_{EX}2 managing the resource of the next MPLS network NW2 (steps S364, S365). The external server LS_{EX}2 confirms the resource and determines the route in the MPLS network NW2 by the same process as the external server LS_{EX}1 (step S366), thereby replying the result (Resource Ans.) to the external server LS_{EX}1 (step S367).

The external server LS_{EX}1 returns the response to the external server LS_{EX}2, and the external servers LS_{EX}1, LS_{EX}2 performs broadcasts (2) and (4) of the TE-LSP No. to the router to be managed for themselves (steps S369, S371, S373, S375, S377, S379). After having received the TE-LSP No., each router returns it to each external server (steps S370, S372, S374, S376, S378, S380). After having received the responses from all of the routers, the external server LS_{EX}1 notifies to the source terminal TE_{A} that the resource has been reserved (step S381), so that the source terminal TE_{A} responsively starts to transmit/receive the traffic (steps S382, S383).

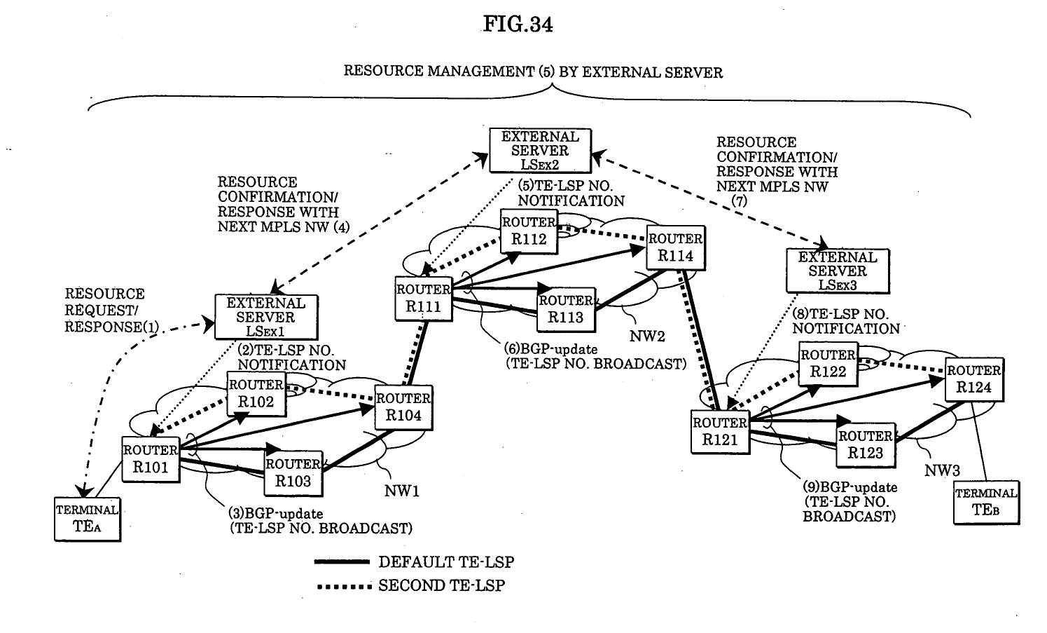

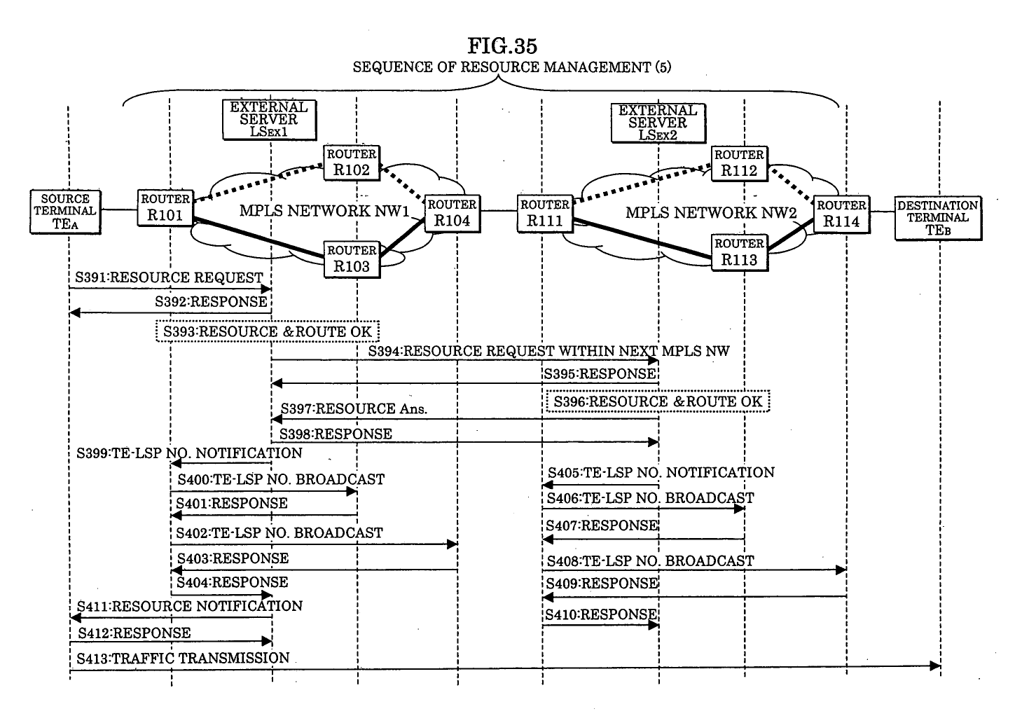

Resource Management Example (5): FIGS. 34 and 35

This resource management example is one which has expanded the resource management example (2) shown in FIGS. 28 and 29, in which the resource management example (2) corresponds to one MPLS network while this resource management example (5) corresponds to the three MPLS networks NW1-NW3 (where the MPLS network NW3 is omitted in FIG. 35 for the simplification of the figure).

The difference between this resource management example (5) and the above resource management example (4) is that the external servers LS_{EX}1, LS_{EX}2 respectively notify the TE-LSP No. to the ingress routers R101, R111.

Namely, after having confirmed if the resource in its subordinate MPLS network NW1 is excessive or lack, the external server LS_{EX} determines which route should be applied (steps S391-S393), so that if the resource within the network is reserved, the external server LS_{EX}1 makes a resource inquiry (confirmation)/response (4) to the external server LS_{EX}2 managing the resource of the next MPLS network NW2 (steps S394, S395). The external server LS_{EX}2 confirms the resource and determines the TE-LSP in its own MPLS network NW2 by the same process as the external server LS_{EX}1 (step S396), thereby replying the result (Resource Ans.) to the external server LS_{EX}1 (step S397). The external server LS_{EX}1 returns the response to the external server LS_{EX}2 (step S398), and the external servers LS_{EX}1, LS_{EX}2 make notifications (2) and (5) of the TE-LSP No. to the ingress router to be managed for its own (steps S399, S405). After having received the TE-LSP No., the ingress routers R101, R111 execute BGP-update (3) and (6) to each of the routers in its MPLS network (steps S400-S410). Each router having received the TE-LSP No. returns the response to the ingress routers R101, R111. After having received the responses from all of the routers, the ingress routers R101, R111 notify to the source terminal TE_{A} that the resource has been reserved (step S411), so that the source terminal TE_{A} responsively starts to transmit/receive the traffic (steps S412, S413).

Thus, it becomes possible to transmit/receive traffics by utilizing resource-reserved routes.

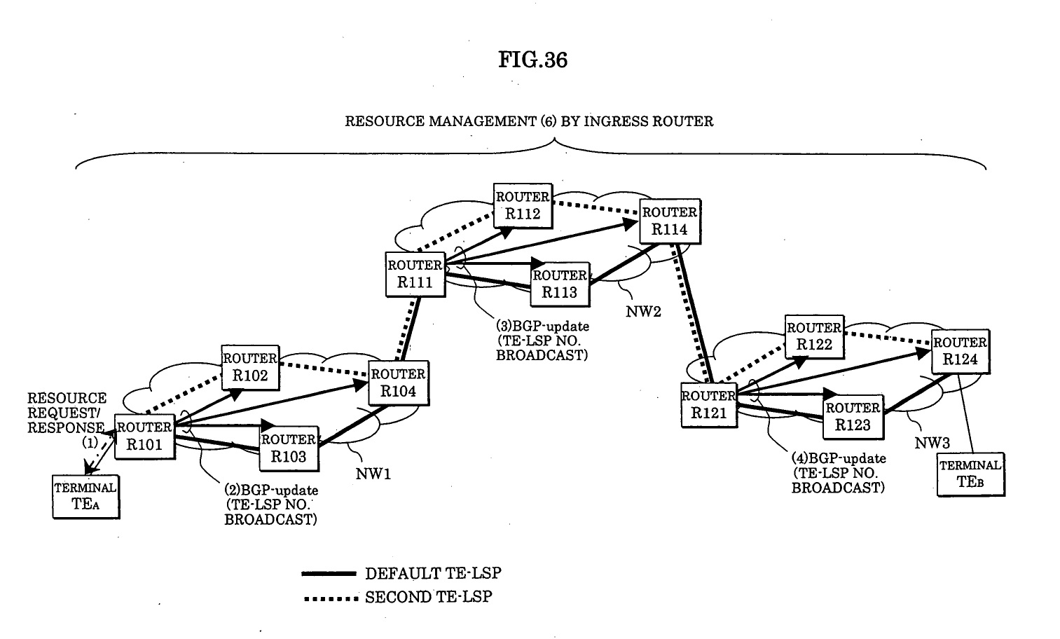

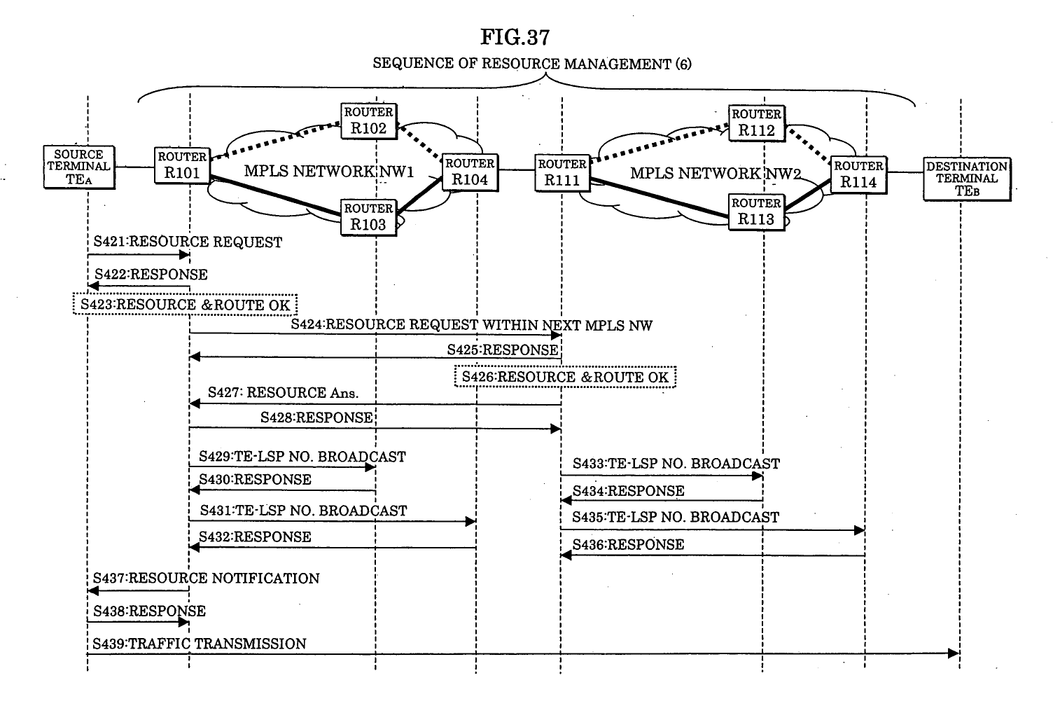

Resource Management Example (6): FIGS. 36 and 37

This resource management example is one which has expanded the resource management example (3) shown in FIGS. 30 and 31 to a plurality of MPLS networks. In this case, the source terminal TE_{A} firstly performs a resource request/response (1) to the ingress router R101 managing the resource of the MPLS network NW1 (steps S421, S422). The ingress router R101 in response to the resource request determines from the destination address an optimum route as in the above, based on the forwarding information table shown in FIG. 38 (step S423). If the resource within the network NW1 is reserved, the ingress router R101 performs a resource inquiry to the ingress router R111 managing the resource of the next MPLS network NW2 (steps S424, S425). The ingress router R111 confirms the resource and determines the TE-LSP of the MPLS network NW2 by the same process as the ingress router R101 (step S426), thereby replying the result (Resource Ans.) to the ingress router R101 (step S427). The ingress router R101 returns to the response to the ingress router R111 (step S428), and performs broadcasts (2) and (3) of the TE-LSP No. by the same BGP-update as the above, to the routers to be managed in the MPLS networks NW1, NW2 to which the ingress routers R101, R111 respectively belong (steps S429, S431, S433, S435). The routers having received the TE-LSP No. return their responses to the ingress router having broadcast the TE-LSP No. (steps S430, S432, S434, S436). After received the responses from all of the routers, each of the ingress routers R101, R111 notifies to the source terminal TE_{A} that the resource has been reserved (step S437), so that the source terminal TE_{A} responsively starts to transmit/receive the traffic (steps S438, S439).

It is to be noted that in the forwarding information table shown in FIG. 38, the destination and the label information are the same while the output port and the TE-LSP No. are different. The difference of the output port represents default/Alternative 1, Alternative 2, . . . etc. Furthermore, the TE-LSP No. is a difference number for designating or selecting the route (default/Alternative) applied after consideration of the resource.

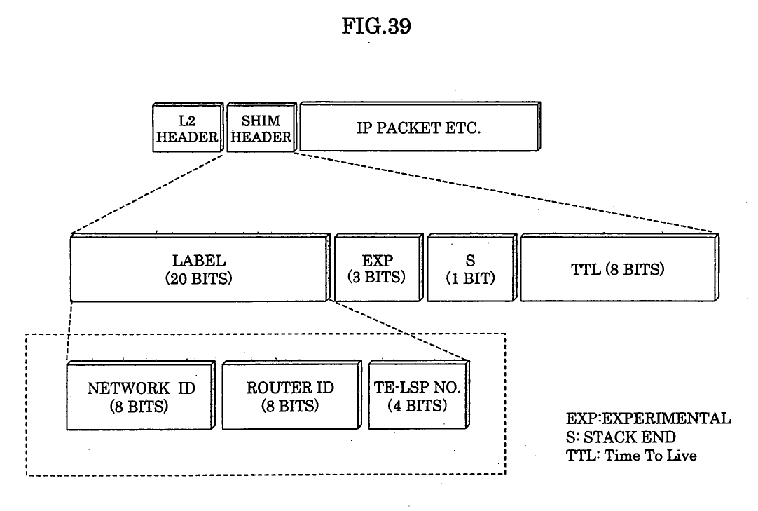

It is also to be noted that the MPLS packet format shown in FIG. 39 defines as one example the label portion formed of a network ID (8 bits), router ID (8 bits), and TE-LSP No. (4 bits).

1. An MPLS network comprising;
an upper layer MPLS network having a TE-LSP for a resource guarantee set up in a mesh form, and
at least one lower layer MPLS network having a TE-LSP for a resource guarantee set up in a mesh form independently of the upper layer MPLS network,
a TE-LSP for a forwarding resource guarantee being set up between routers within the lower layer MPLS network and a gateway router designated within the upper layer MPLS network, and being connected to the TE-LSP set up within the upper layer MPLS network being mutually connected.

2. An MPLS network as claimed in claim 1 wherein when having found an IP packet received to be forwarded through the upper layer network from its destination IP address, the routers within the lower layer MPLS network are set up to embed the IP packet with a destination network ID and a gateway router ID as MPLS label information to be forwarded.

3. An MPLS network as claimed in claim 1 wherein a TE-LSP for a resource guarantee is set up between the MPLS networks of same layer, and when having found an IP packet received to be forwarded through the same layer networks, the routers within the lower layer MPLS network are set up to pass the IP packet through the TE-LSP set up between the same layer MPLS networks without MPLS labeling operations.

4. An MPLS network as claimed in claim 2 wherein the routers within the lower layer MPLS network are initially set up to switch the label information with all other routers within each of the networks by a signaling protocol.

5. An MPLS network as claimed in claim 4 wherein a route reflector is arranged in the gateway router, and the routers within the lower layer MPLS network are initially set up to switch the label information through the route reflector.

6. An MPLS network as claimed in claim 2, further comprising at least one MPLS label server which is set up to perform a unitary management and distribution of the label information for all routers within each of the network.

7. An MPLS network as claimed in claim 6 wherein the MPLS label server is arranged in each of the MPLS networks and is set up to perform a unitary management and distribution of the label information for all routers within its subordinate network and to switch the label information between the label servers.

8. An MPLS network as claimed in claim 1 wherein when the MPLS network that is scalable is connected to an existing MPLS network, and when the gateway router within the scalable MPLS network provided on the border with the existing MPLS network switches the label information with the routers in the existing MPLS network and receives a resource request for the routers within the existing MPLS network from the network of its own, the gateway router sets up the TE-LSP for the routers based on the switched label information.

9. An MPLS network as claimed in claim 8 wherein the scalable MPLS network is connected to be sandwiched between the existing MPLS networks, and is adapted, upon receipt of a resource request from routers in one of the existing MPLS networks to those in the other, to make the gateway router within the scalable MPLS network set up a corresponding TE-LSP based on the label information.

10. An MPLS network as claimed in claim 8 wherein the scalable MPLS network is pluralized so as to be mutually connected to sandwich an existing MPLS network, and is adapted, upon receipt of a resource request from routers in one of the scalable MPLS networks to the other, to set up a corresponding TE-LSP between the gateway routers of the scalable MPLS networks.

11. An MPLS network as claimed in claim 8 wherein an MPLS label server is arranged in each scalable MPLS network, and is set up to perform a unitary management and distribution of the label information for all routers within its subordinate network and to switch the label information between the label servers.

12. An MPLS network as claimed in claim 1 wherein a plurality of resource-guaranteed TE-LSP's are set up between an ingress gateway router and an egress gateway router within a same MPLS network, and the MPLS network further comprises an external server which is set up, upon receipt of a resource request from a source terminal, to select a TE-LSP whose resource is reservable and to broadcast identifying information of the TE-LSP to the routers within the MPLS networks.

13. An MPLS network as claimed in claim 1 wherein a plurality of resource-guaranteed TE-LSP are set up between an ingress gateway router and an egress gateway router within a same MPLS network, and the MPLS network further comprises an external server which is set up, upon receipt of a resource request from a source terminal, to select a TE-LSP whose resource is reservable, and to notify identifying information of the TE-LSP to the ingress gateway router, the ingress gateway router being responsively set up to broadcast the identifying information to other routers.

14. An MPLS network as claimed in claim 1 wherein a plurality of resource-guaranteed TE-LSP's are set up between an ingress gateway router and an egress gateway router within a same MPLS network, and the ingress gateway router is set up, upon receipt of a resource request from a source terminal, to select a TE-LSP whose resource is reservable and to broadcast identifying information of the TE-LSP to other routers.

15. An MPLS network as claimed in claim 12 wherein the MPLS network is pluralized so as to be connected in cascade, each of which is provided with an external server, and resource information of the MPLS network managed by itself is sequentially forwarded between adjoining external servers.

16. An MPLS network as claimed in claim 14 wherein the MPLS network is pluralized so as to be connected in cascade, and resource information of the MPLS network managed by itself is sequentially forwarded between the egress gateway router and the ingress gateway router of adjoining MPLS networks.

17. An MPLS network as claimed in claim 12 wherein when the set up TE-LSP bridges the pluralized MPLS networks, a destination route ID indicating which TE-LSP should be connected is embedded in the label information.

18. An MPLS network architecture method comprising;
a first step of hierarchizing an MPLS network into a plurality of MPLS networks,
a second step of setting up a TE-LSP for a resource guarantee in a mesh form independently in each of the MPLS networks, and
a third step of setting up a TE-LSP for a forwarding resource guarantee between routers within a lower layer MPLS network and a gateway router within an upper layer MPLS network determined at the first step, and of mutually connecting the TE-LSP for a forwarding resource guarantee to the TE-LSP set up within the upper layer MPLS network.

19. An MPLS network architecture method as claimed in claim 18 wherein when having found an IP packet received to be forwarded through the upper layer network from its destination IP address, the routers within the lower layer MPLS network are set up to embed the IP with a destination network ID and a gateway router ID as MPLS label information to be forwarded.

20. An MPLS network as claimed in claim 18 wherein a TE-LSP for a resource guarantee is set up between the MPLS networks of same layer, and when having found an IP packet received to be forwarded through the same layer networks, the routers within the lower layer MPLS network are set up to pass the IP packet through the TE-LSP set up between the same layer MPLS networks without MPLS labeling operations.

21. An MPLS network as claimed in claim 19 wherein the routers within the lower layer MPLS network are initially set up to switch the label information with all other routers within each of the networks by a signaling protocol.

22. An MPLS network as claimed in claim 21 wherein a route reflector is arranged in the gateway router, and the routers within the lower layer MPLS network are initially set up to switch the label information through the route reflector.

23. An MPLS network as claimed in claim 19, further comprising at least one MPLS label server which is set up to perform a unitary management and distribution of the label information for all routers within each of the networks.

24. An MPLS network as claimed in claim 23 wherein the MPLS label server is arranged in each of the MPLS networks and is set up to perform a unitary management and distribution of the label information for all routers within its subordinate network and to switch the label information between the label servers.

25. An MPLS network as claimed in claim 18 wherein when the MPLS network that is scalable is connected to an existing MPLS network, and when the gateway router within the scalable MPLS network provided on the border with the existing MPLS network switches the label information with the routers in the existing MPLS network and receives a resource request for the routers within the existing MPLS network from the network of its own, the gateway router sets up the TE-LSP for the routers based on the switched label information.

26. An MPLS network as claimed in claim 25 wherein the scalable MPLS network is connected to be sandwiched between the existing MPLS networks, and is adapted, upon receipt of a resource request from routers in one of the existing MPLS networks to those in the other, to make the gateway router within the scalable MPLS network set up a corresponding TE-LSP based on the label information.

27. An MPLS network as claimed in claim 25 wherein the scalable MPLS network is pluralized so as to be mutually connected to sandwich an existing MPLS network, and is adapted, upon receipt of a resource request from routers in one of the scalable MPLS networks to the other, to set up a corresponding TE-LSP between the gateway routers within the scalable MPLS networks.

28. An MPLS network as claimed in claim 25 wherein an MPLS label server is arranged in each scalable MPLS network, and is set up to perform a unitary management and distribution of the label information for all routers within its subordinate network and to switch the label information between the label servers.

29. An MPLS network as claimed in claim 18 wherein a plurality of resource-guaranteed TE-LSP's are set up between an ingress gateway router and an egress gateway router within a same MPLS network, and the MPLS network further comprises an external server which is set up, upon receipt of a resource request from a source terminal, to select a TE-LSP whose resource is reservable and to broadcast identifying information of the TE-LSP to the routers within the MPLS networks.

30. An MPLS network as claimed in claim 18 wherein a plurality of resource-guaranteed TE-LSP's are set up between an ingress gateway router and an egress gateway router within a same MPLS network, and the MPLS network further comprises an external server which is set up, upon receipt of a resource request from a source terminal, to select a TE-LSP whose resource is reservable and to notify identifying information of the TE-LSP to the ingress gateway router, the ingress gateway router being responsively set up to broadcast the identifying information to other routers.

31. An MPLS network as claimed in claim 18 wherein a plurality of resource-guaranteed TE-LSP's are set up between an ingress gateway router and an egress gateway router within a same MPLS network, and the ingress gateway router is set up, upon receipt of a resource request from a source terminal, to select a TE-LSP whose resource is reservable and to broadcast identifying information of the TE-LSP to other routers.

32. An MPLS network as claimed claim 29 wherein the MPLS network is pluralized so as to be connected in cascade, each of which is provided with an external server, and resource information of the MPLS network managed by itself is sequentially forwarded between adjoining external servers.

33. An MPLS network as claimed in claim 31 wherein the MPLS network is pluralized so as to be connected in cascade, and resource information of the MPLS network managed by itself is sequentially forwarded between the egress gateway router and the ingress gateway router of adjoining MPLS networks.

34. An MPLS network as claimed in claim 29 wherein when the set up TE-LSP bridges the pluralized MPLS networks, a destination route ID indicating which TE-LSP should be connected is embedded in the label information.
